(19) United States
(12) Patent Application Publication
(10) Pub. No.: US 2014/0019128 A1
(43) Pub. Date: Jan. 16, 2014

(54) Voice Based System and Method for Data Input

(71) Applicants: Daniel J. Riskin, Palo Alto, CA (US); Anand Shroff, San Carlos, CA (US); Yan Chow, Orinda, CA (US); Brian A. Dummett, San Mateo, CA (US); Ritu Raj Tiwari, Foster City, CA (US)

(72) Inventors: Daniel J. Riskin, Palo Alto, CA (US); Anand Shroff, San Carlos, CA (US); Yan Chow, Orinda, CA (US); Brian A. Dummett, San Mateo, CA (US); Ritu Raj Tiwari, Foster City, CA (US)

(21) Appl. No.: 13/929,236

(22) Filed: Jun. 27, 2013

Related U.S. Application Data
(63) Continuation-in-part of application No. PCT/US12/20226, filed on Jan. 4, 2012.
(60) Provisional application No. 61/429,923, filed on Jan. 5, 2011.
(60) Provisional application No. 61/684,733, filed on Aug. 18, 2012.
(60) Provisional application No. 61/719,561, filed on Oct. 29, 2012.
(60) Provisional application No. 61/786,088, filed on Mar. 14, 2013.

(51) Int. Cl. G10L 15/26

(52) U.S. Cl. CPC G10L 15/265
USPC 704/235

(57) ABSTRACT

Described herein are systems and methods for transforming a speech input into machine-interpretable structured data. In some embodiments, a system may include an automated speech recognition (ASR) engine configured to receive a live speech input and to continuously generate a text of the live speech input, a natural language processing (NLP) engine configured to transform the text into machine-interpretable structured data, and a user interface device configured to display the live speech input and a corresponding portion of the structured data in a predetermined order with respect to the structured data. In some embodiments, the method may include the steps of receiving a speech input with a speech capture component of a user interface device, generating a text from the speech input, identifying textual cues in the text, modifying the text based on the textual cues, and transforming the modified text into machine-interpretable structured data.

### CROSS REFERENCE TO RELATED APPLICATIONS

This patent application is a Continuation-In-Part of International Application PCT/US12/20226 filed on Jan. 4, 2012 and titled “A Voice Based System and Method for Data Input” which claims priority to U.S. Provisional Application No. 61/429,923 titled “A Voice Based System and Method for Data Input” and filed Jan. 5, 2011; this patent application also claims the benefit of U.S. Provisional Application No. 61/684,733 filed on Aug. 18, 2012 and titled “Systems and Methods for Processing Patient Information;” this patent application also claims the benefit of U.S. Provisional Application No. 61/719,561 filed on Oct. 29, 2012 and titled “Methods for Clinical Cohort Identification;” this patent application also claims the benefit of U.S. Provisional Application No. 61/786,088 filed on Mar. 14, 2013 and titled “A Voice Based System and Method for Data Input;” each of the applications noted in this paragraph are hereby incorporated herein by reference in their entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### FIELD

Described herein are systems and methods for transforming a speech input into machine-interpretable structured data. In some embodiments, the systems and methods described herein may be utilized with a speech input from a physician describing a patient encounter.

### BACKGROUND

Adoption of electronic health records (EHR) in hospitals and physician offices has been championed as an infrastructure solution to many structural healthcare issues. However, while hospital adoption is more than 50%, of the small practices that represent the large majority of US physicians, only 16% have adopted EHR systems. Practices of less than 10 physicians have typically not purchased EHR products due to their significant purchase and annual maintenance and support costs, as well as negative impact on workflow, for example, workflow delay with loss of productivity.

One significant bather to healthcare information technology (HIT) adoption for SMB physician practices is cost. Despite subsidy and incentive programs, small practices recognize the high cost associated with product and vendor lock-in that prevents future flexibility and the long-term economic impact of decreased practice efficiency.

Furthermore, it is well established that current EHR products cause a measurable drop in patient throughput and therefore lower productivity and reimbursement. The deployment of private practice EHRs has been shown to consistently drop physician productivity by 25-40%, with many studies showing no return to pre-EHR baseline. Small practices cannot afford to lose revenue in a low margin healthcare field or to lose patients due to longer waits and poor patient experience.

Structured data is a prerequisite for automated data analysis, diagnostic and therapeutic decision support, proper billing, real-time disease surveillance, and many other activities beneficial to physicians, patients, regulators, and researchers alike. However, today's EHR systems require manual structuring of information (users must enter data in specified ways into the correct locations), and allow users to make spelling mistakes. Most EHR systems force new physician users to type in their note (few have options for dictation), and also to follow the inherent, often inflexible structure of documentation modules. (e.g., History and Physical (H&P), problem lists, medication lists). EHR systems today have yet to find a balance in structured data entry. They either do too little (i.e., rely predominantly on free text entry) or too much (e.g., strict templates, highly regulated fields with inflexible choices, dropdown lists). In the former case, there is a loss of organization. In the latter case, there is loss of nuanced content, usability, efficiency, and sustainability.

Additionally, driven by the need for structured input, conventional EHR systems interpose both hardware—keyboard, mouse, monitor, and workstation—and software between the physician and the patient. This data entry paradigm fails in medical practices because it introduces significant inefficiencies, distractions, and artificial aberrations into the physician-patient dynamic.

Described herein are devices, systems and methods that may address many of the problems and identified needs described above. By saving time, improving workflow, and collecting fully structured data, the physician can enjoy a more productive and efficient EHR experience and the patient can enjoy more time with the physician. National healthcare goals addressed include priority provider EHR adoption, massive increase in structured data collection, and improved national infrastructure for quality improvement, comparative effectiveness evaluation, clinical research, and informed policy decisions.

### SUMMARY OF THE DISCLOSURE

Described herein are systems and methods for transforming a speech input into machine-interpretable structured data. In general, the systems described herein may include an automated speech recognition (ASR) engine configured to receive a live speech input and to continuously generate a text of the live speech input, a natural language processing (NLP) engine configured to receive the text and to transform the text into machine-interpretable structured data, and a user interface device configured to display the live speech input and a corresponding portion of the structured data in a predetermined order with respect to the structured data such that it may be reviewed, edited, or maintained as a record by a user.

In some embodiments, the display of the portion of the structured data provides real time feedback to the user. In some embodiments, the display of the portion of the structured data promotes effectiveness and comprehensiveness of the speech input from the user.

In some embodiments, the user interface is further configured to display data that was not received as a speech input. In some embodiments, the data that was not received as a speech input is a section heading of an encounter note that has not been received as a speech input.

In some embodiments, the user interface device comprises a speech capture component configured to receive the live speech input. In some embodiments, the user interface device is at least one of a desktop computer, a laptop computer, a tablet computer, a mobile computer, and a smart phone.

In some embodiments, a system for transforming a speech input into machine-interpretable structured data includes an automated speech recognition (ASR) engine configured to receive a speech input and to generate a text of the speech input, a metaspeech processor configured to identify textual cues in the text and to modify the text based on the identified textual cues, and a natural language processing (NLP) engine configured to receive the modified text and to transform the text into machine-interpretable structured data.

In some embodiments, the ASR engine is further configured to receive a portion of the machine-interpretable structured data in addition to the speech input and to generate a text with improved accuracy based on the combination of the speech input and the structured data.

In some embodiments, the speech input includes multiple subject matter sections that include at least two of a history of present illness section, a past medical history section, a past surgical history section, an allergies to medications section, a current medications section, a relevant family history section, and a social history section. In some embodiments, the ASR engine is further configured to receive a portion of the structured data and to thereby classify a current subject matter section of the speech input based on the structured data and to change at least one of a lexicon and a word weighting used to generate the text according to the current section.

In some embodiments, identifying textual cues comprises at least one of identifying keywords in the text and identifying patterns in the text. In some embodiments, the modification based on the identified textual cues includes at least one of organizing the text into sections and replacing words in the text. In some embodiments, the modification based on the identified textual cues includes at least one of changing at least one of a lexicon and a word weighting used by the ASR engine to generate a text.

In some embodiments, the NLP engine is configured to scan the text and to use keywords in the text to transform the text into machine-interpretable structured data. In some embodiments, the NLP engine is configured to employ an algorithm to scan the text and to apply syntactic and semantic rules to the text to transform the text into machine-interpretable structured data.

In some embodiments, a system for transforming a speech input into machine-interpretable structured data includes a user interface device comprising a speech capture component configured to receive a speech input, a natural language processing (NLP) engine configured to receive a text generated from the speech input and to transform the text into machine-interpretable structured data, a data conversion module configured to receive the structured data and to convert the format of the structured data, and a routing module configured to receive the formatted structured data and to send the formatted structured data to a secondary system.

In some embodiments, the secondary system is an Electronic Health or Medical Records (EHR/EMR) system and the data conversion module converts the data to at least one of a HL7 v2.x ADT, an ORU message, a CCD C32, a C48, or a C84 document. In some embodiments, the secondary system is billing system and the data conversion module converts the data to a HL7 v2.x message. In some embodiments, the secondary system is a Public Health Records (PHRs) system and the data conversion module converts the data to CCR and CCD. In some embodiments, the routing module is further configured to maintain an audit log of all of the formatted structured data sent from the system.

In general, a method for transforming a live speech input into machine-interpretable structured data, includes the steps of receiving a live speech input with a speech capture component of a user interface device, continuously generating a text from the live speech input with an automated speech recognition (ASR) engine of a internet-based computer network, transforming the text into machine-interpretable structured data with a natural language processing (NLP) engine of the internet-based computer network, and displaying with a user interface device the live speech input and a corresponding portion of the structured data in a predetermined order with respect to the structured data such that it may be reviewed, edited, or maintained as a record by a user.

In some embodiments, the displaying a portion of the structured data step further includes providing real time feedback to a user. In some embodiments, the displaying step promotes effectiveness and comprehensiveness of the speech input from the user. In some embodiments, the displaying step further includes displaying data that was not received as a speech input. In some embodiments, the displaying step further includes displaying a section heading of an encounter note that has not been received as a speech input.

In some embodiments, a method for transforming a speech input into machine-interpretable structured data includes the steps of generating a text from the speech input with an automated speech recognition (ASR) engine of a internet-based computer network, identifying textual cues in the text, modifying the text based on the textual cues by performing at least one of organizing the text into predetermined sections and substituting words in the text, and transforming the modified text into machine-interpretable structured data with a natural language processing (NLP) engine of the internet-based computer network.

In some embodiments, the speech input includes multiple subject matter sections include at least two of a history of present illness section, a past medical history section, a past surgical history section, an allergies to medications section, a current medications section, a relevant family history section, and a social history section. In some embodiments, the generating a text step further includes classifying the section of the speech input received by the ASR engine based on the structured data. In some embodiments, the generating a text step further includes changing at least one of the lexicon and the word weighting according to the current section of the speech input.

In some embodiments, the identifying textual cues step further includes at least one of identifying keywords and identifying patterns. In some embodiments, the modifying the text step further includes at least one of organizing the text into sections and replacing words in the text. In some embodiments, the modifying the text step further includes at least one of changing at least one of a lexicon and a word weighting used by the ASR engine in the generating a text step.

In some embodiments, the step of transforming the text includes scanning the text for keywords in the text. In some embodiments, the step of transforming the text includes employing an algorithm to scan the text and to apply syntactic and semantic rules to the text.

In some embodiments, a method for transforming a speech input into machine-interpretable structured data includes the steps of receiving a speech input with a speech capture component of a user interface device, transforming the text into machine-interpretable structured data with a natural language processing (NLP) engine of the internet-based computer network, converting the format of the structured data a data conversion module of the internet-based computer network, and sending the formatted structured data over the internet to a secondary system with a routing module.

In some embodiments, the step of sending the formatted structured data includes sending the formatted structured data to an Electronic Health or Medical Records (EHR/EMR) system and the step of converting the format of the structured data includes converting the format of the structured data to at least one of a HL7 v2.x ADT, an ORU message, a CCD C32, a C48, or a C84 document. In some embodiments, the step of sending the formatted structured data includes sending the formatted structured data to a billing system and the step of converting the format of the structured data includes converting the format of the structured data to a HL7 v2.x message. In some embodiments, the step of sending the formatted structured data includes sending the formatted structured data to a Public Health Records (PHRs) system and the step of converting the format of the structured data includes converting the format of the structured data to at least one of CCR and CCD. In some embodiments, the method further includes the step of maintaining an audit log of all of the formatted structured data sent from the system.

In some alternative embodiments, an automated speech recognition (ASR) engine configured to continuously receive a speech input of a note comprising multiple subject matter sections and to generate a text of the note using a lexicon and a word weighting, and a natural language processing (NLP) engine configured to continuously receive the text and to transform the text into machine-interpretable structured data, wherein the ASR engine is further configured to continuously receive a portion of the structured data and to thereby classify a current subject matter section of the speech input and change at least one of the lexicon and the word weighting according to the current section. In some embodiments, the ASR engine is an ASR engine of an internet-based computer network that is configured to receive the speech input over the internet.

In some embodiments, the speech input of a note is a speech input from a physician of an encounter note. In some embodiments, the encounter note comprises at least one of a History and Physical (H&P) note or a Subjective, Objective, Assessment, and Plan (SOAP) note.

In some embodiments, the multiple subject matter sections include at least two of a history of present illness section, a past medical history section, a past surgical history section, an allergies to medications section, a current medications section, a relevant family history section, and a social history section. In some embodiments, wherein the lexicon is a medical vocabulary.

In some embodiments, the NLP engine is configured to scan the text and to use keywords in the text to transform the text into machine-interpretable structured data. In some embodiments, the NLP engine is configured to employ an algorithm to scan the text and to apply syntactic and semantic rules to the text to transform the text into machine-interpretable structured data. In some embodiments, the NLP engine is configured to recognize semantic metadata in the text and to map the semantic metadata to a medical vocabulary. In some embodiments, the semantic metadata are selected from the group comprising concepts, keywords, modifiers, and the relationships between the concepts, keywords, and/or modifiers. In some embodiments, the NLP engine is a NLP engine of an internet-based computer network that is configured to receive the text over the internet.

In some embodiments, the structured data is in at least one of a Clinical Document Architecture (CDA), a Continuity of Care Record (CCR), and a Continuity of Care Document (CCD) format. In some embodiments, the structured data is configured to be compatible with at least one of health information exchanges (HIEs), Electronic Medical Records (EHRs), and personal health records.

In some embodiments, the system further includes a post processor configured to receive the structured data and to transform the structured data into in at least one of a Clinical Document Architecture (CDA), a Continuity of Care Record (CCR), and a Continuity of Care Document (CCD) format. In some embodiments, the structured data is configured to be used in at least one of a clinical effectiveness evaluation; a research trial; clinical decision support; computer-assisted billing and medical claims; and automated reporting for meaningful use, quality, and efficiency improvement.

In general, the systems described herein may include an a user interface device comprising a speech capture component configured to receive a speech input, an automated speech recognition (ASR) engine configured to receive the speech input and to generate a text of the speech input, a metaspeech processor configured to identify textual cues in the text and to modify the text based on the identified textual cues, and a natural language processing (NLP) engine configured to receive the modified text and to transform the text into machine-interpretable structured data.

In some embodiments, the user interface device is at least one of a desktop computer, a laptop computer, a tablet computer, a mobile computer, and a smart phone. In some embodiments, the user interface device is further configured to receive a video input. In some embodiments, the user interface device is further configured to receive a biometric authentication.

In some embodiments, identifying textual cues comprises at least one of identifying keywords and identifying patterns. In some embodiments, the modification based on the identified textual cues includes at least one of organizing the text into sections and replacing words in the text. In some embodiments, the modification based on the identified textual cues includes at least one of changing at least one of a lexicon and a word weighting used by the ASR engine to generate a text.

In some embodiments, the ASR engine is further configured to receive the machine-interpretable structured data in addition to the speech input and to generate a text based on the combination of the speech input and the structured data.

In some embodiments, the user interface is further configured to display a portion of the structured data in a predetermined order. In some embodiments, the user interface is further configured to display a portion of the structured data such that it may be reviewed and/or edited by a user. In some embodiments, the display of the portion of the structured data promotes effectiveness and comprehensiveness of the speech input from the user. In some embodiments, the user interface is further configured to display data that is not structured data from the NLP engine.

In some embodiments, the system further includes a data conversion module configured to receive the structured data and to convert the format of the structured data. In some embodiments, the system further includes a routing module configured to receive the formatted structured data and to send the formatted structured data to a secondary system. In some embodiments, the secondary system is an Electronic Health or Medical Records (EHR/EMR) system and the data conversion module converts the data to at least one of a HL7 v2.x ADT, an ORU message, a CCD C32, a C48, or a C84 document. In some embodiments, the secondary system is billing system and the data conversion module converts the data to a HL7 v2.x message. In some embodiments, the secondary system is a Public Health Records (PHRs) system and the data conversion module converts the data to CCR and CCD. In some embodiments, the routing module is further configured to maintain an audit log of all of the formatted structured data sent from the system.

In general, the systems described herein may include a user interface device comprising a speech capture component configured to receive a speech input, an automated speech recognition (ASR) engine of an internet-based computer network configured to receive the speech input over the internet and to generate a text of the speech input, and a natural language processing (NLP) engine of an internet-based computer network configured to receive the text over the internet and to transform the text into machine-interpretable structured data and to deliver over the internet a portion of the structured data to the user interface device.

In general, the methods described herein may include the steps of continuously receiving a speech input with an automated speech recognition (ASR) engine of an internet-based computer network, wherein the speech input comprises multiple subject matter sections, generating a text from the speech input with the ASR engine using a lexicon and a word weighting, transforming the text with a natural language processing (NLP) engine of the internet-based computer network into machine-interpretable structured data, classifying the section of the speech input received by the ASR engine based on the structured data, and changing at least one of the lexicon and the word weighting according to the current section of the speech input.

In some embodiments, the receiving a speech input step comprises receiving a speech input over the internet. In some embodiments, the receiving a speech input step comprises receiving a speech input from a physician of an encounter note. In some embodiments, the receiving a speech input step comprises receiving a speech input comprising at least one of a History and Physical (H&P) note or a Subjective, Objective, Assessment, and Plan (SOAP) note. In some embodiments, the multiple subject matter sections include at least two of a history of present illness section, a past medical history section, a past surgical history section, an allergies to medications section, a current medications section, a relevant family history section, and a social history section. In some embodiments, the lexicon is a medical vocabulary.

In some embodiments, the step of transforming the text comprises scanning the text for keywords in the text. In some embodiments, the step of transforming the text comprises employing an algorithm to scan the text and to apply syntactic and semantic rules to the text. In some embodiments, the step of transforming the text comprises recognizing semantic metadata in the text and mapping the semantic metadata to a medical vocabulary. In some embodiments, the semantic metadata are selected from the group comprising concepts, keywords, modifiers, and the relationships between the concepts, keywords, and/or modifiers. In some embodiments, the step of transforming the text comprises receiving the text over the internet. In some embodiments, the step of transforming the text comprises transforming the text into structured data in at least one of a Clinical Document Architecture (CDA), a Continuity of Care Record (CCR), and a Continuity of Care Document (CCD) format. In some embodiments, the step of transforming the text comprises transforming the text into structured data that is configured to be compatible with at least one of health information exchanges (HIEs), Electronic Medical Records (EHRs), and personal health records.

In some embodiments, the method further includes the step of post processing the structured data into in at least one of a Clinical Document Architecture (CDA), a Continuity of Care Record (CCR), and a Continuity of Care Document (CCD) format. In some embodiments, the method further includes the step of using the structured data in at least one of a clinical effectiveness evaluation; a research trial; clinical decision support; computer-assisted billing and medical claims; and automated reporting for meaningful use, quality, and efficiency improvement.

In general, the methods described herein may include the steps of receiving a speech input with a speech capture component of a user interface device, generating a text from the speech input with an automated speech recognition (ASR) engine of a internet-based computer network, identifying textual cues in the text, modifying the text based on the textual cues by performing at least one of organizing the text into predetermined sections and substituting words in the text, and transforming the modified text into machine-interpretable structured data with a natural language processing (NLP) engine of the internet-based computer network.

In some embodiments, the identifying textual cues step further comprising at least one of identifying keywords and identifying patterns. In some embodiments, the modifying the text step further comprising at least one of organizing the text into sections and replacing words in the text. In some embodiments, the modifying the text step further comprising at least one of changing at least one of the lexicon and the word weighting used by the ASR engine in the generating a text step.

In some embodiments, the method further includes the step of providing feedback to a user by displaying with the user interface device a portion of the structured data. In some embodiments, the method further includes the step of receiving a video input with a video capture component of a user interface device. In some embodiments, the method further includes the step of receiving a biometric authentication with the user interface device. In some embodiments, the method further includes the steps of classifying a subject matter section of the speech input received by the ASR engine based on the structure data and changing at least one of a lexicon and a word weighting of the ASR engine according to the current subject matter section of the speech input.

In some embodiments, the method further includes the step of displaying a portion of the structured data in a predetermined order on the user interface device. In some embodiments, the method further includes the step of converting the format of the structured data. In some embodiments, the method further includes the step of sending the formatted structured data to a secondary system with a routing module. In some embodiments, the step of sending the formatted structured data comprises sending the formatted structured data to an Electronic Health or Medical Records (EHR/EMR) system and the step of converting the format of the structured data comprises converting the format of the structured data to at least one of a HL7 v2.x ADT, an ORU message, a CCD C32, a C48, or a C84 document. In some embodiments, the step of sending the formatted structured data comprises sending the formatted structured data to a billing system and the step of converting the format of the structured data comprises converting the format of the structured data to a HL7 v2.x message. In some embodiments, the step of sending the formatted structured data comprises sending the formatted structured data to a Public Health Records (PHRs) system and the step of converting the format of the structured data comprises converting the format of the structured data to at least one of CCR and CCD. In some embodiments, the step of maintaining an audit log of all of the formatted structured data sent from the system.

In some embodiments, a method for transforming a speech input into machine-interpretable structured data includes the steps of continuously receiving a speech input with an automated speech recognition (ASR) engine of an internet-based computer network, wherein the speech input includes multiple subject matter sections, generating a text from the speech input with the ASR engine using a lexicon and a word weighting, transforming the text with a natural language processing (NLP) engine of the internet-based computer network into machine-interpretable structured data, classifying the section of the speech input received by the ASR engine based on the structured data, and changing at least one of the lexicon and the word weighting according to the current section of the speech input.

In some embodiments, the receiving a speech input step includes receiving a speech input over the internet. In some embodiments, the receiving a speech input step includes receiving a speech input from a physician of an encounter note. In some embodiments, the receiving a speech input step includes receiving a speech input including at least one of a History and Physical (H&P) note or a Subjective, Objective, Assessment, and Plan (SOAP) note. In some embodiments, the multiple subject matter sections include at least two of a history of present illness section, a past medical history section, a past surgical history section, an allergies to medications section, a current medications section, a relevant family history section, and a social history section. In some embodiments, the lexicon is a medical vocabulary.

In some embodiments, the step of transforming the text includes scanning the text for keywords in the text. In some embodiments, the step of transforming the text includes employing an algorithm to scan the text and to apply syntactic and semantic rules to the text. In some embodiments, the step of transforming the text includes recognizing semantic metadata in the text and mapping the semantic metadata to a medical vocabulary. In some embodiments, the semantic metadata are selected from the group including concepts, keywords, modifiers, and the relationships between the concepts, keywords, and/or modifiers. In some embodiments, the step of transforming the text includes receiving the text over the internet. In some embodiments, the step of transforming the text includes transforming the text into structured data in at least one of a Clinical Document Architecture (CDA), a Continuity of Care Record (CCR), and a Continuity of Care Document (CCD) format. In some embodiments, the step of transforming the text includes transforming the text into structured data that is configured to be compatible with at least one of health information exchanges (HIEs), Electronic Medical Records (EHRs), and personal health records.

In some embodiments, a method for transforming a speech input into machine-interpretable structured data includes the steps of receiving a speech input with an automated speech recognition (ASR) engine of an internet-based computer network, generating a text from the speech input with the ASR engine using a first library, transforming the text with a natural language processing (NLP) engine of the internet-based computer network into machine-interpretable structured data, determining a context of the text based on the structured data;

generating an updated text from the speech input with the ASR engine using a second library selected based on the context of the text, and transforming the updated text with the NLP engine of the internet-based computer network into updated machine-interpretable structured data.

In some embodiments, the first library is a general medical library and the second library is more specific than the first library. In some embodiments, the second library is a context specific speech library.

In some embodiments, the determining a context of the text step includes performing a postprocessing analysis of the structured data. In some embodiments, the determining a context of the text step includes classifying the subject matter section of the speech input received by the ASR engine based on the structured data. In some embodiments, the determining a context of the text step further includes at least one of identifying keywords and identifying patterns. In some embodiments, the determining a context of the text step further includes scanning the text for keywords in the text. In some embodiments, determining a context of the text step further includes employing an algorithm to scan the text and to apply syntactic and semantic rules to the text.

In some embodiments, the receiving a speech input step comprises receiving a speech input over the internet. In some embodiments, the speech input comprises multiple subject matter sections include at least two of a history of present illness section, a past medical history section, a past surgical history section, an allergies to medications section, a current medications section, a relevant family history section, and a social history section.

In some embodiments, the receiving a speech input step includes receiving a speech input from a physician of an encounter note. In some embodiments, the receiving a speech input step includes receiving a speech input comprising at least one of a History and Physical (H&P) note or a Subjective, Objective, Assessment, and Plan (SOAP) note. In some embodiments, the step of transforming the text includes transforming the text into structured data in at least one of a Clinical Document Architecture (CDA), a Continuity of Care Record (CCR), and a Continuity of Care Document (CCD) format.

In some embodiments, the transforming the text steps further comprising organizing the text into sections. In some embodiments, the step of transforming the text comprises transforming the text into structured data that is configured to be compatible with at least one of health information exchanges (HIEs), Electronic Medical Records (EHRs), and personal health records.

In some embodiments, a method for building a speech library for an automated speech recognition (ASR) engine includes the steps of providing a plurality of texts, wherein each text includes a plurality of words and at least one of a plurality of predetermined subject matter sections, wherein the words are divided into the subject matter sections, selecting one of the plurality of predetermined subject matter sections, filtering the plurality of texts to include the words of the selected subject matter section, and creating a data file that includes the words in the filtered text and the frequency at which those words occur.

In some embodiments, the providing a plurality of texts step further including providing text of a plurality of physician encounter notes. In some embodiments, each of the encounter notes are a History and Physical (H&P) note or a Subjective, Objective, Assessment, and Plan (SOAP) note. In some embodiments, the plurality of predetermined subject matter sections include at least two of a history of present illness section, a past medical history section, a past surgical history section, an allergies to medications section, a current medications section, a relevant family history section, and a social history section.

In some embodiments, the filtering step further including filtering the plurality of texts with a natural language processing (NLP) engine. In some embodiments, the filtering step further including scanning the plurality of texts and using keywords in the text to filter the plurality of texts to include the words of the selected subject matter section. In some embodiments, the filtering step further including employing an algorithm to scan the plurality of texts and to apply syntactic and semantic rules to the text to filter the plurality of texts to include the words of the selected subject matter section. In some embodiments, the filtering step further including recognizing semantic metadata in the plurality of texts. In some embodiments, the semantic metadata are selected from the group including concepts, keywords, modifiers, and the relationships between the concepts, keywords, and/or modifiers.

In some embodiments, the method further includes the step of creating a data file that includes phonemes in the filtered text, the words that are included of the phonemes, and the frequency at which those words occur. In some embodiments, the method further includes the steps of selecting a second predetermined subject matter section, filtering the plurality of texts to include the words of the second selected subject matter section, and creating a data file that includes the words in the filtered text and the frequency at which those words occur.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIGS. 1-3 illustrate exemplary embodiments of systems and methods for transforming a speech input into machine-interpretable structured data.

FIGS. 4A-4E illustrate exemplary embodiments of a display of a user interface device.

FIG. 5 illustrates an exemplary embodiment of a system and method for transforming a speech input into machine-interpretable structured data by utilizing an NLP engine to identify context of the speech input.

FIG. 6 illustrates an exemplary embodiment of a system and method for transforming a speech input into machine-interpretable structured data.

FIG. 7 illustrates the system and method described herein comprising a Automated Language Intent System.

FIG. 8 illustrates the system described herein comprising plug-in architecture.

FIGS. 9A and 9B illustrate the system described herein comprising architecture for a scalable ASR server.

### DETAILED DESCRIPTION

Described herein are systems and methods for transforming a speech input into machine-interpretable structured data. In some embodiments, the systems and methods described herein may be utilized with a speech input from a physician of an encounter note.

In some embodiments, the system may be a speech-driven encounter recording system that converts physician voice into fully structured encounter data, while simultaneously delivering a superior user experience and improving workflow throughput. In some embodiments, the system may be a “cloud-based” (e.g. internet or web-based) system. Alternatively, the system and methods may be performed on a computer having specific software. For example, the computer may be a specific electronic health records (EHR) computing system. By using speech input that is converted directly to fully coded and structured electronic health records (EHR) data (i.e. an EHR compliant encounter note), physicians can save time, improve the accuracy of their notes, increase usable information, avoid third-party transcription errors, and mitigate workflow delays. The output may be fully coded. In some embodiments, this differs from conventional systems which may only code the problem list and medication list. In some examples, the majority of useful content is in the history of present illness section, which is usually the largest note section and the only section that describes the reason for the visit and any related clinical events. Generally, this critical medical content is not coded by conventional systems.

The systems and methods described herein may allow a physician to quickly enter data in an intuitive way that produces machine-interpretable structured output which may be automatically integrated into an EHR using industry standards. In various embodiments, the same structured output may be leveraged for billing codes, quality measures, clinical decision support, comparative effectiveness evaluation, research, and other desirable applications.

In some embodiments, the system may eliminate several minutes of data entry associated with each patient, particularly for complex cases. The system and method may allow a physician to dictate an encounter note, such as an History and Physical (H&P) note or a Subjective, Objective, Assessment, and Plan (SOAP) note, into a user interface device, for example an iPhone™, Blackberry™, or computer. The speech input (e.g., physician voice) may then be processed “in the cloud” (e.g. via internet-based computing) into text. The text may then be processed in real time into structured information via a natural language processing (NLP) engine, also “in the cloud”. The structured data may be used to allow better voice processing within a given section of the encounter note as the physician dictates. Sections of the encounter note may include for example a history of present illness section, a past medical history section, a past surgical history section, an allergies to medications section, a current medications section, a relevant family history section, a social history section, and any combination thereof. The structured data may also be used to give real time feedback to the physician so they can better complete their dictation. For example, a physician or other user may be able to see which sections have been completed, how the completed sections have been structured or organized, and which sections have not been completed. The physician may immediately review the results, including a preview of the resulting document (e.g. a Clinical Document Architecture (CDA) document). After making any necessary modifications, the physician may approve the document. In some embodiments, the information may then be automatically pushed into an EHR system.

As described, the system may include an automatic speech recognition (ASR) engine and a natural language processing (NLP) engine. The NLP engine may be configured to influence either (1) the dictation of the user or (2) the ASR engine generation of text from a speech input. The system may thereby improve (1) the user (e.g. physician) experience, (2) the specific information captured (e.g. sections of an encounter note), (3) the voice processing accuracy (e.g. of the ASR engine), or (4) tagged information accuracy (e.g. accuracy of the structured data).

As described herein, a system and method for transforming a speech input into machine-interpretable structured data may include an automated speech recognition (ASR) engine configured to continuously receive a speech input and to generate a text. The speech input, for example, a dictation from a physician, may be an alternative to inputs required by conventional EHR recoding systems. When conventional EHR usage requires primary care physicians who have dictated for years to start typing during an office visit, it creates a workflow disruption that is often insurmountable for users. Dictation may be may be a superior alternative. For example, it is not only a well-established practice, but perhaps the most accurate way to capture timely patient information during or immediately following the visit.

As part of medical training, physicians master presenting patients in a structured verbal format. Using a consistent verbal structure, most physicians find dictation natural and often preferable to typing. The majority of small practice physicians dictate or use pen and paper rather than EHR systems. The systems and methods described herein may take advantage of the logical workflow taught in medical school and residency, allowing physicians to think about, document, and present patients in the way that is most natural to them. By integrating real-time structured feedback, automated speech recognition (ASR), natural language processing (NLP), and an abstraction layer on top of the EHR, the systems and methods described herein may eliminate or greatly reduce the challenge for physicians of converting from comfortable speech narrative to uncomfortable keyboard entry.

Furthermore, the systems and methods described herein may have the flexibility to adapt to natural physician workflow. The physician may chart (e.g. record encounter information) during the patient interview, post interview, or in batch mode during breaks. The systems and methods described herein may allow the user to skip freely between chart sections, filling in data where appropriate and as directed by the patient encounter in a natural manner, unlike conventional EHR systems that require physicians to manually hunt-and-peck between sections. The systems and methods described herein may flag critical missing data and offer real-time feedback during dictation.

By using speech input converted automatically to fully coded and structured EHR data (i.e. an EHR compliant encounter note), physicians can improve note accuracy, increase usable information, avoid third-party coding limitations, and mitigate workflow delay. National healthcare goals addressed include priority provider EHR adoption, massive increase in structured data collection, and improved national infrastructure for local and regional quality improvement, comparative effectiveness evaluation, clinical research, and informed policy decisions.

The systems and methods described herein may allow a physician to maintain better eye contact with the patient, which increases the patient's trust and assurance that the physician is paying attention to their concerns. As practice performance is increasingly linked to patient satisfaction, connecting with the patient may become even more important over time. On the patient's part, a personal connection may produce more openness and willingness to disclose information, as well as better compliance with treatment, recommendations, and follow-up.

The systems and methods described herein may also allow a physician to maintain closer physical proximity to the patient, including appropriate touch, which facilitates the caring relationship the physician wishes to develop with the patient. This also leads to improved patient communication and engagement. Increase perceived physician attention as reflected in the amount of time the physician spends listening to the patient and acknowledging or responding to concerns. This helps to establish the trust relationship between physician and patient, and improves the patient experience.

The systems and methods described herein may increase efficiency by guiding the patient encounter without distraction while accommodating how the physician thinks and physician workflow. Distraction has been shown to be one of the major causes of medical error leading to morbidity and mortality in the hospital setting. A conventional PC interface can be highly distracting because it represents a gating factor; at certain points, the encounter cannot proceed unless the requirements of the data entry interface are met. This stands in stark contrast to the physician-patient interaction, which is flexible, conversational, and mutually directed.

The systems and methods described herein may decrease data entry time and effort by transferring the responsibility for structuring entered data from the physician to the systems and methods described herein. Again, the task of categorizing and organizing data during data entry is a significant distraction that may slow the physician down and reduce efficiency and productivity. The systems and methods described herein may increase productivity and flexibility by allowing the physician to quickly follow new lines of inquiry or pursue unanticipated findings without being required to navigate through multiple screens to locate the correct place to enter specific data. Speech-driven commands are often faster than physical screen navigation using keyboard and mouse.

The systems and methods described herein may increase productivity by providing metaspeech accelerators similar to keyboard macros that can perform scripted actions to save time and reduce errors. This aspect provides expansion capabilities that can be personalized for each physician as well as each physician office setup.

The systems and methods described herein may interact more naturally with a real-time audio and/or visual feedback system for data correction or editing. This system may help the physician maintain awareness of the current status and context of encounter documentation, even with the inevitable interruptions of a busy practice.

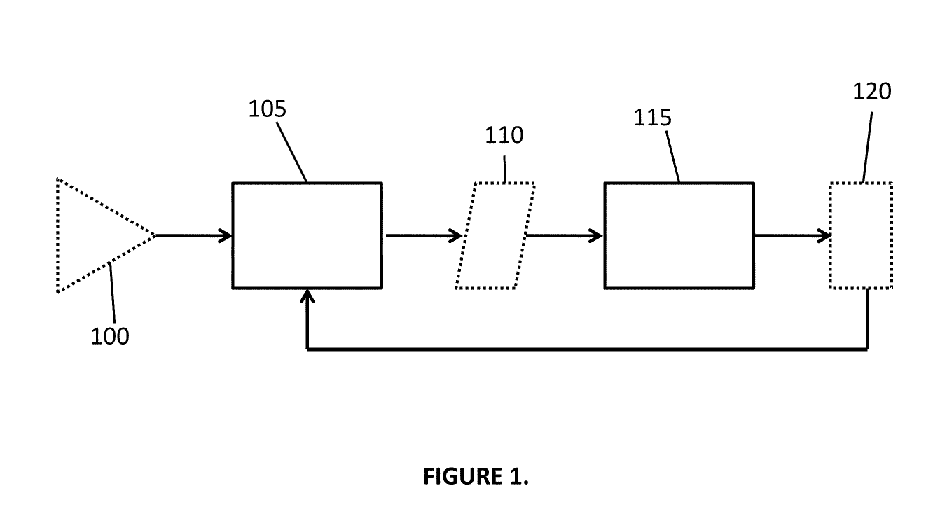

FIGS. 1-3 illustrate exemplary embodiments of systems and methods for transforming a speech input into machine-interpretable structured data. As shown in FIG. 1, in some embodiments, a system for transforming a speech input 100 into machine-interpretable structured data may include an automated speech recognition (ASR) engine 105 configured to continuously receive a speech input and to generate a text 110 and a natural language processing (NLP) engine 115 configured to continuously receive the text and to transform the text into machine-interpretable structured data 120. As shown, in some embodiments, the ASR engine is further configured to continuously receive a portion of the structured data and to thereby generate text according to the structured data received. Also as shown in FIG. 1, a method for transforming a speech input into machine-interpretable structured data may include the steps of continuously receiving a speech input with an ASR engine of an internet-based computer network, generating a text from the speech input with the ASR engine, transforming the text with a NLP engine of the internet-based computer network into machine-interpretable structured data, classifying a subject matter section of the speech input received by the ASR engine based on the structured data, and generating the text according to the current section of the speech input.

As shown in FIG. 1, an ASR engine may be configured to continuously receive a speech input and to generate a text of the speech input. In some embodiments, the ASR engine (e.g. voice recognition component), may be a component of a “cloud-based” (e.g. internet or web-based) system. For example, the ASR engine may be an ASR engine of an internet-based computer network that is configured to receive the speech input over the internet.

In some embodiments, the ASR engine may be configured to generate a text using at least one lexicon (e.g. a vocabulary or group of words, such as a comprehensive medical vocabulary) and/or a word weighting (e.g. likelihood that a given word is actually the word that was spoken or dictated). The ASR engine may pass the generated text onto the NLP engine, as described in detail below, where the text is transformed into structured data. The structured data, or a portion thereof, may be fed back to the ASR engine. The structured data may be used to change or modify one of the lexicon or the word weighting. For example, the structured data may be used by the ASR engine to determine additional information about the speech input that is currently being inputted.

In some embodiments, the speech input may be a speech input from a physician of an encounter note. For example, the encounter note may be a History and Physical (H&P) note or a Subjective, Objective, Assessment, and Plan (SOAP) note. As such, the note may include multiple subject matter sections. The multiple subject matter sections may include any of a history of present illness section, a past medical history section, a past surgical history section, an allergies to medications section, a current medications section, a relevant family history section, and a social history section, etc.

As described above, the structured data may be used by the ASR engine to determine additional information about the speech input that is currently being inputted. In the example of the physician encounter note, the structured data may be used to determine that the subject matter of the note that is currently being dictated is the current medications section, for example. The ASR engine may therefore change one of the lexicon, the word weighting, or the speech library according to the subject matter and thereby increase the accuracy of the text generation from the speech input. Therefore in this example, the ASR engine may use a lexicon and/or a word weighting and/or speech library that is specific to the current medications section. More specifically, if the ASR engine were to receive the speech input of the word “AMBIEN”, a brand name prescription medication used for the short-term treatment of insomnia, conventionally this word might easily be confused for the word “ambient”, defined as “something that surrounds”. However, if the ASR engine employs the lexicon and/or a word weighting and/or a speech library that is specific to the current medications section, the ASR engine might be more likely to generate a text correctly including the word “AMBIEN”, rather than the incorrect word “ambient”. For example, the current medications lexicon may not include the word “ambient” at all. Alternatively the current medications word weighting may give a higher weight to “AMBIEN” over “ambient”, thereby increasing the likelihood that the text of “AMBIEN” (rather than “ambient”) will be generated from the spoken word of “AMBIEN”. Furthermore, with an integrated domain-specific lexicon, the ASR engine may eliminate spelling mistakes and extraneous information by generating a text-based transcription automatically from spoken input.

Within the clinical patient encounter note there are specific subject matter sections, these sections are typically rigorously followed by physicians through a century of medical tradition and based on current billing requirements. The sections make frequent use of words that are seldom found elsewhere and may be misinterpreted by conventional speech to text systems. Examples include the Medication List section, or Past Medical History section, in which words are often complex and vocabulary is heavily constrained. Conventional systems do not take into account medical context-specific probabilities when converting speech to text, in deciding how to recognize each spoken word throughout the physician narrative. Within the clinical patient encounter note there are specific sections, and within each section, words are complex and vocabulary is heavily constrained, and therefore well suited for context sensitive recognition. As an example, an ASR engine trained on a general language model would convert speech that sounds like “loopus” into “loops” which occurs far more frequently than the term “lupus” in everyday speech. However, taking into account that the physician is currently narrating the “Past Medical History” section (determined by a portion of the structured data from the NLP engine), in which “lupus” is far more common than “loops”, would address this problem. Taking context-specific probabilities into account in order to accurately transcribe speech may be completed by the ASR engine real-time, to enable physician feedback and EMR population during patient encounter. Further, in some embodiments, the system may take into account words that are commonly translated incorrectly by an ASR engine. As in the example above, an ASR engine may convert a spoken “lupus” to a textual “loops” and this may be a common mistake make while translating speech to text in a medical context. Therefore, the system may be configured to replace the textual “loops”, when encountered, with a textual “lupus”.

As an example, a conventional system trained even on a medical language model may still mistakenly convert certain words. For example, a conventional system may convert speech that sounds like “lupus” into “new pus”, terms which independently occur far more frequently in healthcare than “lupus”. However, taking into account that the physician is currently narrating the “Past Medical History” section, in which “lupus” is far more common than “pus”, would address this problem. Thus, the system described herein may take context-specific probabilities into account in order to accurately transcribe speech should ideally be performed real-time, to enable physician feedback and EMR population during routine medical workflow.

There is an opportunity to incorporate real-time NLP of contextual data into ASR, to actually change the ongoing ASR process. The systems described herein may use statistical analysis of historical medical records to create families of language models for each section of the traditional medical note and switch lexicons in and out of the ASR real time based on contextual position within the narrative note. Conventional systems cannot do context sensitive recognition because they do not have integrated NLP and do not have tight integration with the core code of their ASR.

As described above, the structured data may be used by the ASR engine to determine additional information about the speech input that is currently being inputted, for example, the structured data may allow the system to take context-specific probabilities (that a specific word is going to occur) into account while generating the text from the speech input. More specifically, there is an opportunity to utilize the structured data from the NLP engine, such as contextual data, to actually change the ongoing ASR engine text generation process. In some embodiments, a statistical analysis of historical medical records may be utilized to create families of language models (i.e. lexicons) for each subject matter section of the traditional medical note (e.g. past medical history, medications, etc.) and switch lexicons in and out of the ASR engine real time based on the contextual position (i.e. which subject matter section) within the narrative note. In these embodiments, the ASR engine may utilize a Section-Specific Statistical Language Model (SS-SLM) specialized in recognizing speech pertaining to specific sections of a patient encounter note. The ASR engine may further include a SS-SLM switching mechanism that may be triggered based on real-time structured data from the NLP engine (e.g. concept capture), enabling utilization of optimized, context sensitive SLMs.

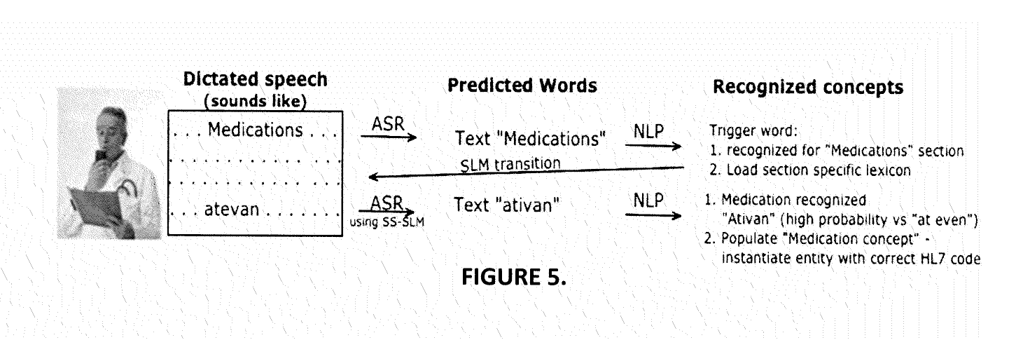

As shown in FIG. 5, the system may utilize an ASR engine to generate a text from a spoken input, followed by an NLP engine to identify context for the text. The context may then be utilized to adapt subsequent (or retroactively adapt) ASR engine text generation. As the physician speaks, a live input stream may be processed by an ASR engine and an NLP engine. When a physician uses (i.e. dictates) a trigger keyword, predicted by the system to indicate that a new section is being addressed, the section-specific statistical language model is loaded into the ASR engine and used in subsequent ASR engine text generation until a new section is identified. In some embodiments, a physician may therefore record the encounter in the nonlinear fashion that is typical for a patient visit. For example, as shown in FIG. 5, a user may dictate the speech input including the word “Medications”. The ASR engine may then receive this speech input and generate the text of this speech input, which includes the word “Medications”. The NLP engine may then receive the text from the ASR engine. The NLP engine may be configured to recognize the word “Medications”. This may then be sent back to the ASR engine or otherwise trigger the loading or switching to a specific lexicon. For example, the ASR engine may load a medications specific lexicon. As the ASR engine continues to generate text from the spoken input, the ASR engine may then generate the text of “atvian” from the subsequent spoken input. In some embodiments, a conventional ASR engine may have generated the text of “at even” rather than correctly transcribing the medication name of “ativan”. With the medication specific lexicon loaded, the ASR engine may be more likely to correctly generate the text for “ativan”.

In some embodiments, a SS-SLM may be a one dimensional model based on the subject matter section or a two dimensional model based on the subject matter section and the medical specialty, for example Allergy & Immunology, Family Medicine, Obstetrics & Gynecology, etc. The ASR engine may utilize the SS-SLMs in one of several variations. For example, an ASR engine may include a single recognizer that is configured to listen to commands and to switch between SS-SLMs real-time. Alternatively, the ASR engine may include a bank of recognizers that may be loaded in memory, one tuned for each subject matter section, and the speech input may be routed by a controller to the correct recognizer upon recognition of section-specific trigger words (in some embodiments, by and NLP engine). In some embodiments, the ASR engine may include a command processor that is configured to listen to commands, and upon the detection of trigger words, may indicate that an SS-SLM should be loaded to process the subsequent speech input.

In practice, the ASR engine may include at least one recognizer that receives the structured data, determines the subject matter section, and switches between SS-SLMs accordingly. In some embodiments, the ASR engine may include a bank of recognizers that may be loaded in the memory of the ASR engine, one tuned for each subject matter section. Depending on the subject matter section the speech input may be routed by a controller to the correct recognizer upon recognition of section-specific trigger words. Alternatively, in some embodiments, the ASR engine may include a command processor that recognizes section-specific trigger words, and upon detection of trigger words, loads the appropriate SS-SLM to process the subsequent speech input.

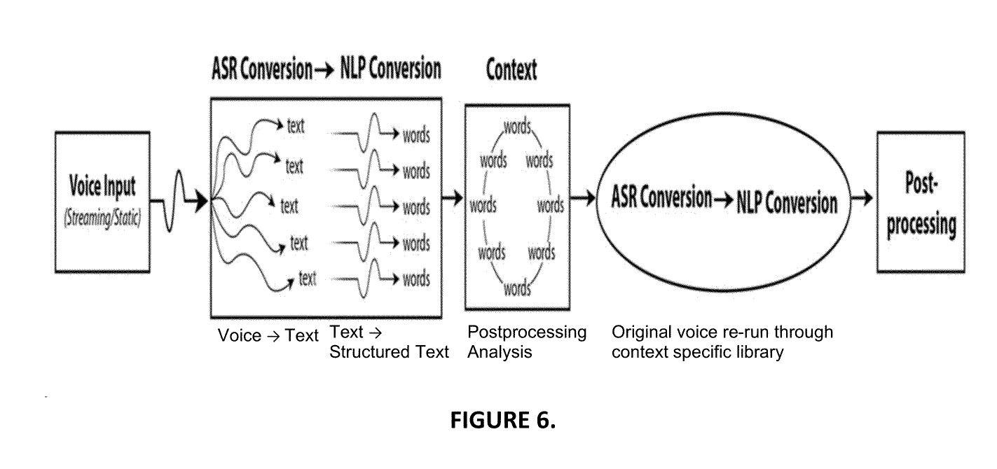

As described herein the system may exploit the statistical variability between language usage in each subject matter section of a medical record or encounter note. As described, this may further be done in real time as the encounter note is dictated. In some embodiments, as shown in FIG. 6 for example, a method for transforming a speech input into machine-interpretable structured data may include the steps of receiving a speech input (e.g. voice input) with an automated speech recognition (ASR) engine of an internet-based computer network, generating a text from the speech input with the ASR engine using a first library, transforming the text with a natural language processing (NLP) engine of the internet-based computer network into machine-interpretable structured data (e.g. “words”), determining a context of the text based on the structured data (e.g. in a postprocessing analysis), generating an updated text with the ASR engine using a second library selected based on the context of the text, and transforming the updated text with the NLP engine of the internet-based computer network into updated machine-interpretable structured data.

As described above, in the step of generating a text from the speech input with the ASR engine using a first library, an ASR engine may, for example, use a general library such as a general medical library. The ASR engine may then switch to a more specific library to generate the updated text. The ASR may switch libraries based on the context that can be determined from a postprocessing analysis of the NLP engine's structured data. The new library selected may be a context specific speech library. Once a new library is selected, the original voice content may be run again through the ASR engine to generate an updated text with the correct context specific speech library. The updated text may then be transformed by the NLP engine into updated machine-interpretable structured data.

Conventional speech recognition methods may use only a single general-purpose medical lexicon to train a recognizer when identifying words, however accuracy can therefore be flawed in some instances because medical context-specific probabilities are ignored. Conventional methods do not exploit the variation between these contexts while deciding how to recognize spoken words throughout a physician narrative. There is an opportunity to utilize NLP contextual data to change the ongoing ASR process, or rerun the ASR process as described above.

Context may be defined as the section (or subject matter) of a medical encounter note, such as Medications, Past Medical History, Allergies, and the like. Within the clinical patient encounter note there are specific sections. These sections have been rigorously followed through a century of medical tradition as well as current billing requirements in the formats of History and Physical (H&P) or Subjective, Objective, Assessment, and Plan (SOAP). Typically, the most complex patient encounters are documented in the H&P format, which is rigorous and consistent. The sections make frequent use of words that are seldom found elsewhere and can be misinterpreted by conventional ASR systems. For instance, within the Medication List section, or Past Medical History section of the H&P, words are complex and vocabulary is heavily constrained, creating a perfect opportunity for context sensitive recognition.

Taking context-specific probabilities into account in order to accurately transcribe speech may be performed real-time, to enable physician feedback and EMR population during routine medical workflow, at times when patient information is recalled accurately and when physicians prefer to complete their documentation.

Also described herein is a method for building a speech library (e.g. a Section-Specific Statistical Language Model (SS-SLM)) for an automated speech recognition (ASR) engine. A statistical analysis of historical medical records may be utilized to create families of language models for each section of a traditional medical note. SS-SLMs for each chart section encountered may enable increased accuracy and specificity in predicting words from acoustic sequence (e.g. speech input). Conventional systems cannot do context sensitive recognition because they do not have integrated an NLP engine and do not have tight integration with the core code of their ASR engine. In some embodiments, the method includes the steps of providing a plurality of texts. Each text may include a plurality of words and at least one of a plurality of predetermined subject matter sections. The words may be divided into the predetermined subject matter sections. The method may also include the steps of selecting one of the plurality of predetermined subject matter sections, filtering the plurality of texts to include the words of the selected subject matter sections, and creating a data file that includes the words in the filtered text and the frequency at which those words occur.

In some embodiments, the plurality of texts provided are texts of physician encounter notes. The texts may be in a specific format. For example, physician encounter notes are typically dictated (or otherwise entered) in one of two formats: a History and Physical (H&P) note or a Subjective, Objective, Assessment, and Plan (SOAP) note. In some embodiments, the plurality of texts may be all H&P notes, all SOAP notes, or a combination thereof. In some embodiments, the plurality of texts may include several hundred individual texts. Alternatively, the plurality of texts may include several thousand or even about a million individual texts or more.

As described above, each text may include a plurality of words and at least one of a plurality of predetermined subject matter sections. For example, an H&P note may include any number of the following sections: history of present illness section, a past medical history section, a past surgical history section, an exam findings section, an allergies to medications section, a current medications section, a relevant family history section, a social history section, and any other suitable section. A SOAP note may include a subjective section, an objective section, an assessment section, and a plan section. The words of each of the texts may be divided into the predetermined subject matter sections.

For example, in one embodiment, the plurality of texts may include two H&P notes. The first H&P note may include a history of present illness section, a current medications section, and an exam findings section. The second H&P note may include only a history of present illness section and an exam findings section. Each section includes words that are relevant to that section. As described above, the method may also include the step of selecting one of the plurality of predetermined subject matter sections. For example, the section selected may be the history of present illness section. As described above, the method may also include the step of filtering the plurality of texts to include the words of the selected subject matter sections. In this example, the selected section is the history of present illness section, and the plurality of texts will therefore be filtered to include all the words of the history of present illness section of the first H&P note, and all the words of the history of present illness section of the second H&P note. Alternatively, for example, if the section selected was current medications section, the plurality of texts would therefore be filtered to include all the words of the current medications section of the first H&P note and nothing from the second H&P note, because the second H&P note, in this example, does not include a current medications section.

In some embodiments, the filtering step may further include filtering the plurality of texts with a natural language processing (NLP) engine (discussed in more detail below). In some embodiments, an NLP engine may infer patterns of language usage from text of each section within the H&P (or SOAP) documentation format. The patterns of language inferred may include the detection of section boundaries to be used as trigger words for invoking a new or alternative SS-SLM and/or the detection of characteristic word distributions of each section. Statistical processing of each section may separately determine a section-specific word weighting distribution scheme.

For example, the filtering step may include scanning the plurality of texts with the NLP engine and using keywords in the text to filter the plurality of texts to include the words of the selected subject matter section. Alternatively, in some embodiments, the filtering step with the NLP engine may include employing an algorithm to scan the plurality of texts and to apply syntactic and semantic rules to the text to filter the plurality of texts to include the words of the selected subject matter section. The NLP engine may recognize semantic metadata in the plurality of texts. The semantic metadata may be concepts, keywords, modifiers, and the relationships between the concepts, keywords, and/or modifiers.

As described above, a data file may be created including the words in the filtered text and the frequency at which those words occur. In some embodiments, the method may further include the step of creating a data file that includes phonemes in the filtered text, the words that are comprised of the phonemes, and the frequency at which those words occur. In general, an ASR engine typically does not look for word in a speech input, it is looking for phonemes. A phoneme is a segmental unit of sound, an acoustic utterance. An ASR engine will then put together a trigram—a set of three phonemes that are most likely matches the portion of the received speech input. Then, for a given word, an ASR engine will combine trigrams. For example, for the word ATIVAN (a trade name for a tranquilizer used to treat anxiety and tension and insomnia, for example), having three syllables, each syllable will have a trigram of likely phonemes. The ASR engine will then take the trigrams and/or combination of phonemes and consult a library or lexicon to determine the text word that should be generated. In some embodiments, the data file or speech library may include a map of all phonemes to non-medical words, all phonemes to medical words, and a weighting of which words are most likely to exist.

In some embodiments, the method may further include the steps of selecting a second predetermined subject matter section, filtering the plurality of texts to include the words of the second selected subject matter section, and creating a data file that includes the words in the filtered text and the frequency at which those words occur. In other words, the method may be repeated for an alternative subject matter section. The steps of the method may be repeated until a speech library is created for each possible subject matter section.

In one specific embodiment of the method described above for a method for building a speech library for an automated speech recognition (ASR) engine, the method includes the steps for processing about one million text based narrative internal medicine patient encounter notes in History and Physical (H&P) formats using NLP techniques to determine section boundaries and keywords. An automated approach to automatically structuring narrative notes by combining text classification and Hidden Markov Modeling (HMM) techniques, to categorize each sentence of the note, may be utilized. Section boundary detection may be augmented using the Columbia University-based MedLEE natural language processing system, which provides robust concept detection for section markers stated heterogeneously in the text (such as “History of present illness”, “Past history”, etc.). In this specific example the result is, per patient encounter note, an array of text segments; one segment for each section of the encounter note.

Returning to FIG. 1, an NLP engine may be configured to continuously receive the text generated by the ASR engine and to transform the text into machine-interpretable structured data. The NLP engine may analyze the textual output of the ASR engine and restructure the output into standardized clinical components including section delineation and removal of extraneous spoken content. This step may enable subsequent processing by a concept coding NLP system, which may be configured for processing of manually transcribed notes and not necessarily spoken clinical content. The concept coding NLP system may convert well-presented content to SNOMED coded concepts.

To allow physicians to speak normally, the system described herein may be able to infer their intent and restructure and punctuate the textual output of the ASR engine. The NLP engine described herein may obviate the need for speech modification, such as special spoken commands or punctuation. The system may build on a formal representation of clinical workflow and event handling through sequence chart modeling, for example Harel sequence chart modeling. In some embodiments, the NLP engine is a NLP engine of an internet-based computer network that is configured to receive the text over the internet. The NLP engine may transform the text into machine-interpretable structured data by associating tags with specific keywords—for instance labeling the work “hypertension” within a past medical history section. In some embodiments, the NLP engine employs algorithms to scan unstructured text, apply syntactic and semantic rules to extract computer-understandable information, and create a targeted, standardized representation. Alternatively, the NLP engine may simply scan the text for keywords (e.g. hypertension) and associate a tag with the word (e.g. “past medical history”). For example, the NLP engine is configured to scan the text to identify keywords in the text and to use keywords in the text to transform the text into machine-interpretable structured data.

In some embodiments, the NLP engine recognizes semantic metadata (concepts, their modifiers, and the relationships between them) in the text generated by the ASR engine and maps the semantic metadata to a relevant coded medical vocabulary. This allows data to be used in any system where coded data is required. This can include reasoning-based clinical decision support systems, computer-assisted billing and medical claims, and automated reporting for meaningful use, quality, and efficiency improvement. The output of the NLP engine is typically formatted in a machine-interpretable structured document (XML), which facilitates handling of the NLP engine output by the data conversion module described below. The output of the NLP engine may also be made available to the physician as described below for a final review (if they so choose) so that the structured data can be edited and any errors introduced in the NLP phase can be corrected. In some embodiments, the structured data may be formatted in one of a Clinical Document Architecture (CDA), a Continuity of Care Record (CCR), and a Continuity of Care Document (CCD) format. The structured data is configured to be compatible with at least one of health information exchanges (HIEs), Electronic Medical Records (EHRs), and personal health records.

In some embodiments, the systems and methods may further include a post processor configured to receive the structured data and to transform the structured data into in at least one of a Clinical Document Architecture (CDA), a Continuity of Care Record (CCR), and a Continuity of Care Document (CCD) format. For example, the post processor may be configured to take the structured output from the NLP engine and to transcode it into a standard format suitable for an EHR system. In some embodiments, the structured data may be configured to be used in at least one of a clinical effectiveness evaluation; a research trial; clinical decision support; computer-assisted billing and medical claims; and automated reporting for meaningful use, quality, and efficiency improvement.

The exchange of health information between healthcare entities has been a high federal priority for many years. However, for various reasons the vast majority of EHRs, including enterprise products, do not easily permit this exchange. However, the systems and methods described herein may be designed to work with key healthcare IT technologies such as health information exchanges (HIEs), EHRs, and personal health records. By interposing an abstraction layer on top of the EHR, the systems and methods described herein have the potential to exchange health information with other systems in industry standard formats such as CCR, CCD, and CDA, in a way that is transparent to healthcare providers, patients, and other stakeholders. Because the system's architecture offers a capability for straightforward health information exchange, the systems and methods can facilitate population-wide disease surveillance, medical interventions, public health announcement broadcasting, and other proposed benefits of HIEs.

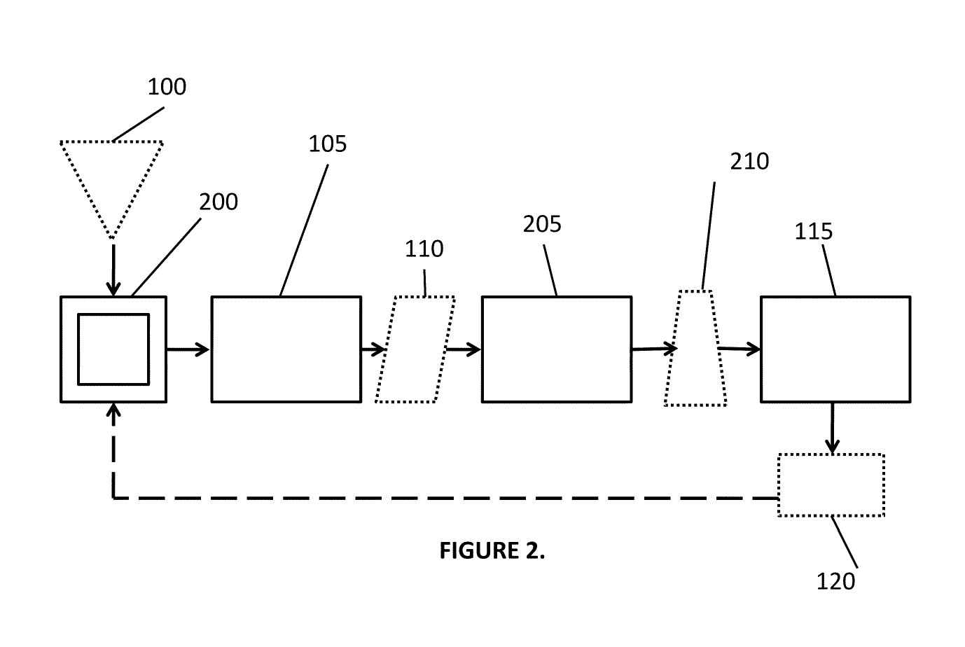

As shown in FIG. 2, in some embodiments, a system for transforming a speech input into machine-interpretable structured data may include a user interface device 200 comprising a speech capture component configured to receive a speech input 100, an automated speech recognition (ASR) engine 105 configured to receive the speech input and to generate a text of the speech input 110, a metaspeech processor 205 configured to modify the text 210, and a natural language processing (NLP) engine 115 configured to receive the modified text 210 and to transform the text into machine-interpretable structured data 120. In some embodiments, a system may transform a live speech input (i.e. real time) into machine-interpretable structured data. The system may include an automated speech recognition (ASR) engine configured to receive a live speech input and to continuously generate a text of the live speech input, a natural language processing (NLP) engine configured to receive the text and to transform the text into machine-interpretable structured data, and a user interface device configured to display the live speech input and a corresponding portion of the structured data in a predetermined order with respect to the structured data such that it may be reviewed, edited, or maintained as a record by a user.

Also as shown in FIG. 2, a method for transforming a speech input into machine-interpretable structured data may include the steps of receiving a speech input with a speech capture component of a user interface device, generating a text from the speech input with an ASR engine of a internet-based computer network, identifying textual cues in the text, modifying the text based on the textual cues by performing at least one of organizing the text into predetermined sections and substituting words in the text, and transforming the modified text into machine-interpretable structured data with a NLP engine of the internet-based computer network. In some embodiments, a method for transforming a live speech input, real time, into machine-interpretable structured data may include the steps of receiving a live speech input with a speech capture component of a user interface device, continuously generating a text from the live speech input with an automated speech recognition (ASR) engine of an internet-based computer network, transforming the text into machine-interpretable structured data with a natural language processing (NLP) engine of the internet-based computer network, and displaying with a user interface device the live speech input and a corresponding portion of the structured data in a predetermined order with respect to the structured data such that it may be reviewed, edited, or maintained as a record by a user. The display of the portion of the structured data may provide real time feedback to the user.

As shown in FIG. 2, the systems and methods may include a user interface device including a speech capture component configured to receive a speech input. The user interface device may be a desktop computer, a laptop computer, a tablet computer, a mobile computer, a smart phone, and/or any combination thereof. In some embodiments, speech may be captured either through a built-in microphone, or an integrated or attached microphone. The capture component may be integrated into the local user interface with support for all necessary peripheral devices.

In some embodiments, the user interface device is the primary means by which a physician may interact with the system. The user interface may be developed for several form factors, including PC/laptop, tablet computer, and a smartphone. As described below, the user interface may also provide feedback system 325 that displays interactive feedback based on the real-time analysis of the structured data. The interface device may also support final review and proof editing before finalizing a document. In some embodiments, the user interface device may be further configured to receive a video input. The user interface device may be further configured to receive a biometric authentication through voice, video, fingerprint, etc.

In some embodiments, the user interface is further configured to display a portion of the structured data in a predetermined order such that it may be reviewed and/or edited by a user. For example, as chief complaint, history of present illness, and other items are entered by voice at the physician's pace, AFI may provide real-time audio and/or visual feedback to maintain user context, allow immediate corrections, and confirm processing. The display of the portion of the structured data may promote effectiveness and comprehensiveness of the speech input from the user. In some embodiments, the user interface is further configured to display data that is not structured data from the NLP engine. For example, the user interface device may display information that represents data from the speech input that has not been provided by the user. For example, the user interface may list subject matter headings of an encounter note that have not been inputted or completed.

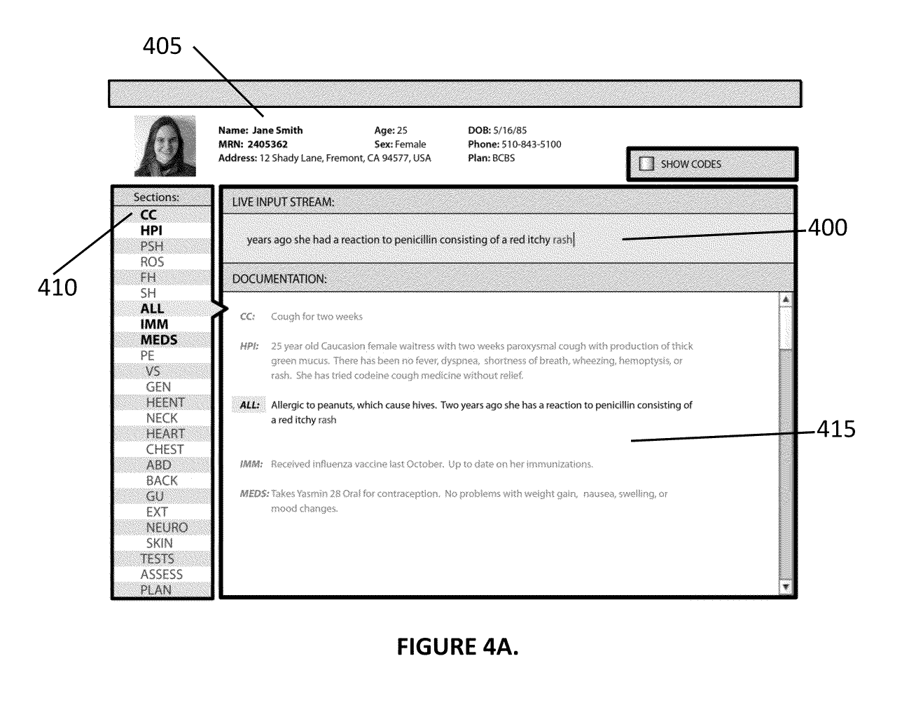

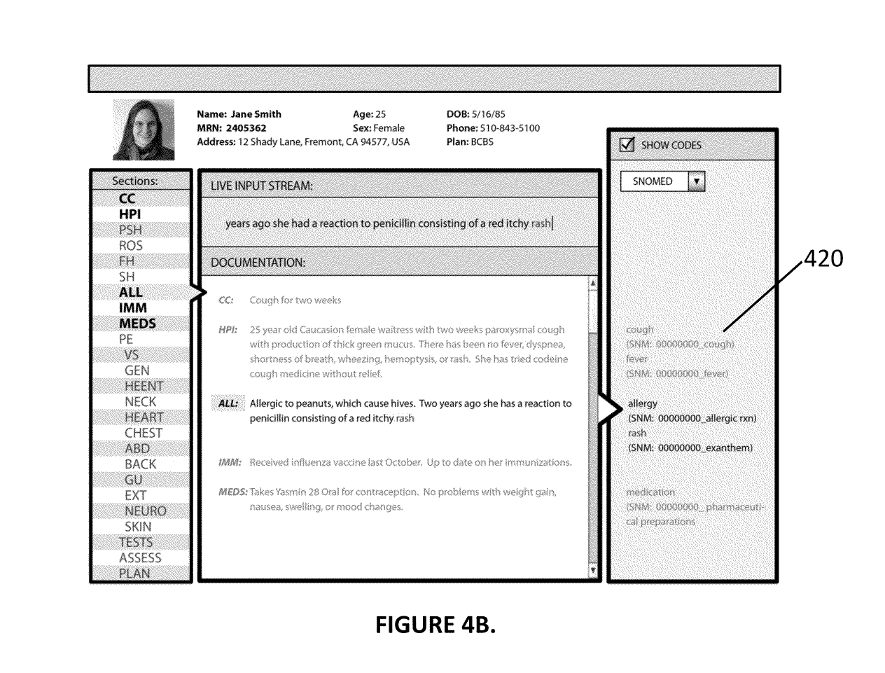

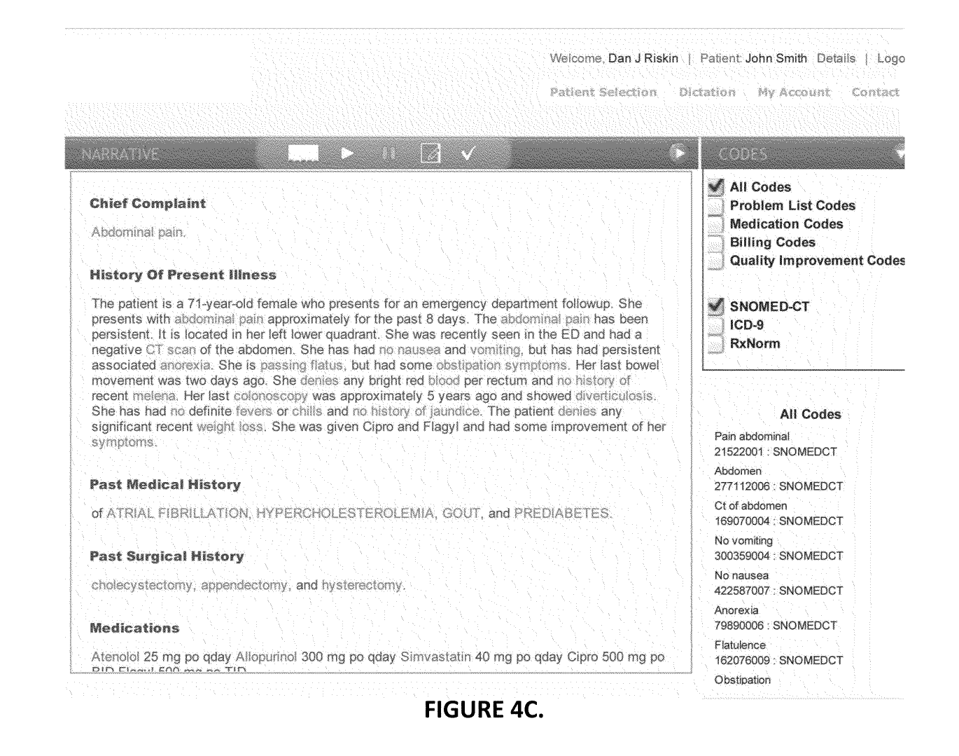

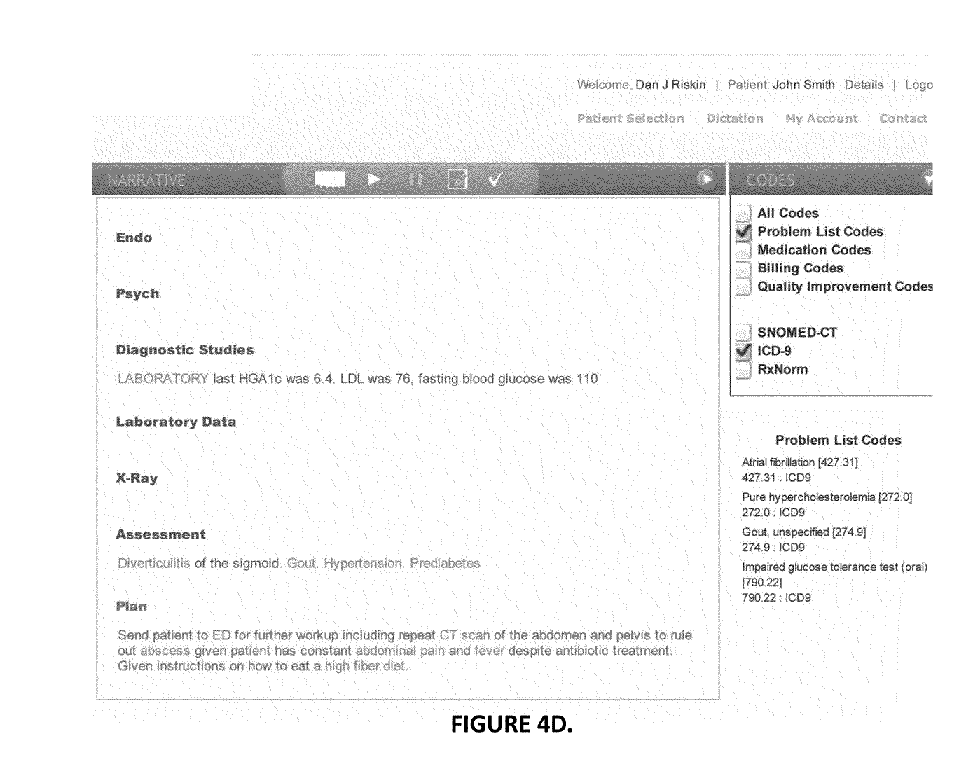

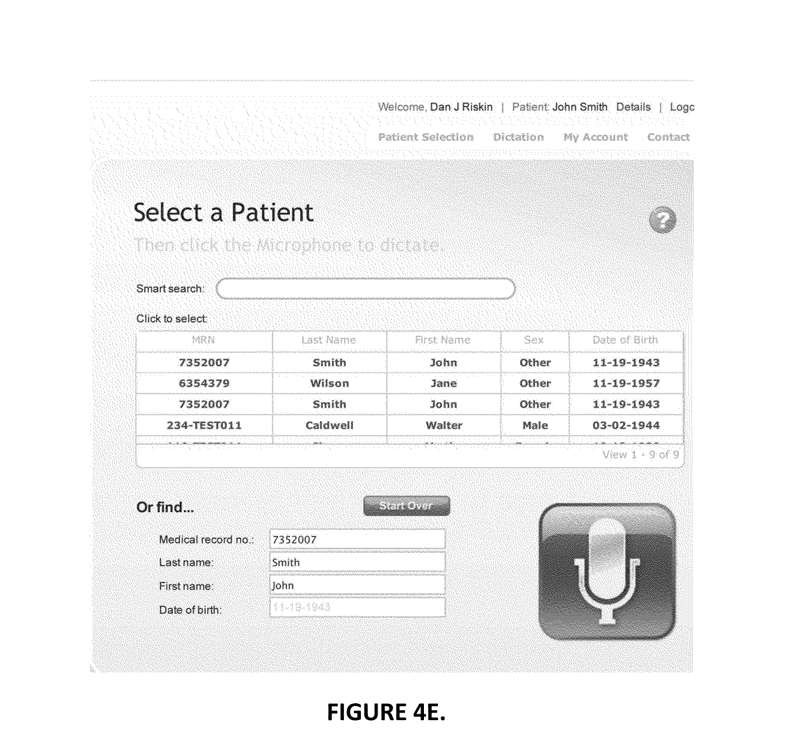

FIGS. 4A and 4B illustrate exemplary embodiments of a display of a user interface device. As shown, as a physician speaks, the live input stream 400 may be processed by the system (e.g. the ASR engine and the NLP engine). When a physician uses a trigger keyword predicted by the system to indicate a new section is being addressed, the section-specific statistical language model or library may then be loaded into the ASR engine and used in subsequent speech to text conversion by the ASR engine until a new section is identified. A physician may therefore record the encounter in the nonlinear fashion that is typical for a patient visit, with high voice-to-text accuracy due to context specific real-time processing. As shown in FIG. 4A, a user interface display may include details about the patient including age, gender, and other bibliographical information 405. Additionally, the display may include a list of subject matter sections 410. These sections may be the subject matter sections that correspond to a typical encounter note, such as a History and Physical (H&P) note or a Subjective, Objective, Assessment, and Plan (SOAP) note. For example, the sections may include a current condition (CC) section, a history of present illness (HPI) section, an allergies to medications section (ALL), an immunizations (IMM) section, and a current medications section (MEDS). As shown, each of these sections is listed in bold font in the user interface display. This indicates that these sections have been received and/or completed via a speech input. Those sections not listed in bold have not been received or completely received via a speech input. As shown, to the right of the sections list, the structured data is listed in the documentation section 415 of the display. As shown, each of the bold sections, CC, HPI, ALL, IMM, and MEDS, each have text and/or structured data associated with them in the document.

Furthermore, the user interface display may display the live input stream. As shown, the live input stream may be the current or “live” text generated from the speech input by the ASR engine. Alternatively, the live input stream may be the structured data from the NLP engine. As shown, the live input stream is “years ago she had a reaction to penicillin consisting of a red itchy rash”. As shown, “rash” is highlighted. This may indicate that “rash” is a keyword. In some embodiments, the keyword “rash” may lead the current speech input to be classified as fitting within the “ALL” section. As shown, the “ALL” section is therefore highlighted in the list as this section is currently being inputted or edited. Further, the system may generate codes in real time. For example, the highlighted word, “rash” for example, may indicate a word that has a corresponding code. For example, the spoken word “rash” may be converted to a textual “rash” and may also be converted to a code for “rash” or “allergy”, as shown in FIG. 4B.

As shown, the system may receive a speech input of an encounter note in any order. For example, the speech input may be in the order observed by a physician during an encounter or examination. The system may use real time structuring of the speech input to create an ordered note (e.g. in a predetermined order) and to give real time feedback 325 to the dictator to improve experience, information dictated, or the way the physician speaks to improve note accuracy or organization.

Additionally, as shown in FIG. 4A (top right corner), a user may have an option to further display codes. As shown in FIG. 4B, this box in the top right corner is selected and the codes 420 are listed. As shown, SNOMED is selected from the dropdown menu. SNOMED stands for Systematized Nomenclature of Medicine and is a multiaxial, hierarchical classification system. SNOMED is a systematically organized computer processable collection of medical terminology that allows a consistent way to index, store, retrieve, and aggregate clinical data across specialties and sites of care. Alternatively, any other suitable coding or classification system may be shown. For example, ICD or RxNorm. ICD is the International Classification of Disease, which is a standardized classification of disease, injuries, and causes of death, by etiology and anatomic localization and codified into a 6-digit number.

As shown in FIGS. 4C and 4D, as in to FIGS. 4A and 4B, the user interface may include a dictation interface. FIG. 4C illustrates the highlighting of codes within the structured note (center panel), and the listing of codes (right panel). For example, the words “abdominal pain” are highlighted in the center panel. The corresponding codes relating to the abdomen are displayed in the right panel. The codes that are determined by the system based on the speech input can be used for quality analytics and billing, for example. FIG. 4D illustrates the highlighting of codes within the structured note (center panel), and the listing of ICD 9 codes (right panel) selected for billing purposes. For example, under the heading “Assessment”, the words “Diverticulitis”, “Gout”, “Hypertension”, and “Prediabetes” are highlighted within the structured note.

As shown in FIG. 4E, the user interface may further provide an interface for a user to select a patient or to enter new patient information. As shown, a user (e.g. physician) may search for an existing patient by entering in keywords such as the patient's name, medical record number (MRN), gender, and/or date of birth. Once the patient is selected, the user may then dictate a note for that patient. As shown, the user may initiate a recording of an encounter note by clicking or selecting the microphone button. Once the user begins the dictation of the encounter note, the user interface may transition from the patient selection screen (FIG. 4C) to the dictation interface (FIG. 4A, 4B, 4D, or 4E).

Returning to FIG. 2, the systems and methods may further include a metaspeech processor configured to identify textual cues in the text and to modify the text based on the identified textual cues. In some embodiments, the textual cues may include keywords, patterns, etc. The modification based on the identified textual cues may include organizing the text into sections, replacing words in the text, etc. The modification based on the identified textual cues may improve the accuracy of the NLP engine and the structured data. In some embodiments, the modification based on the identified textual cues may include changing the lexicon and/or the word weighting used by the ASR engine to generate a text. Metaspeech may be defined as tags assigned to the text generated from a speech input. The metaspeech, or tags, may be used to improve accuracy in voice recognition and data structuring.

The metaspeech processor may take the output of the ASR engine and process it for robust and error-free consumption by the NLP engine. The metaspeech processor may also launch and control other clinical and business applications distinct from encounter documentation. The system metaspeech processor may further include a metaspeech interpreter and a well-defined lexicon of command tags. The metaspeech processor may maximize physician productivity by allowing natural, optimized patterns of diagnostic thought expressed through speech, a medium already being employed during a patient encounter.

For example, as described above in reference to FIGS. 4A and 4B, the live input stream (e.g. speech input) may be for example, “years ago she had a reaction to penicillin consisting of a red itchy rash”. As shown, “rash” is highlighted. In this case, the keyword “rash” may be tagged by the metaspeech processor with “allergies to medications”.

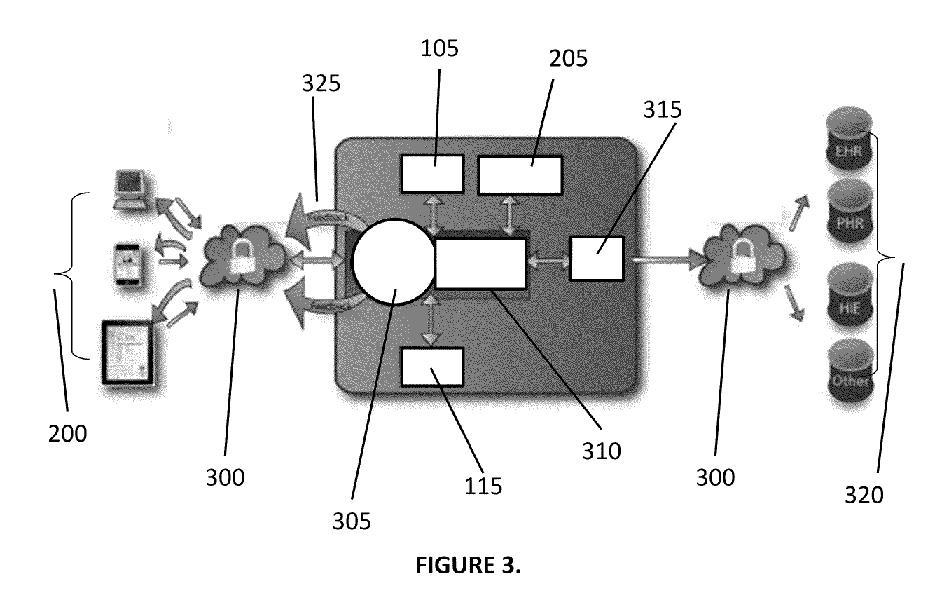

As shown in FIG. 3, in some embodiments, a cloud computing system for transforming a speech input into machine-interpretable structured data may include a user interface device 200 comprising a speech capture component configured to receive a speech input, an automated speech recognition (ASR) engine 105 of an internet-based computer network configured to receive the speech input over the internet 300 and to generate a text of the speech input, and a natural language processing (NLP) engine 115 of an internet-based computer network configured to receive the text over the internet and to transform the text into machine-interpretable structured data. In some embodiments, the system is configured to deliver over the internet a portion of the structured data to the user interface device.

In some embodiments, the cloud-based system may be run on a cloud computing system such as the Amazon EC2 and/or the Microsoft Azure cloud computing services. Cloud computing may reduce the cost of infrastructure by an order of magnitude. In addition, systems that run applications 305 “in the cloud” (i.e., running on a server 310 securely accessible over the Internet) may require less infrastructure, for example they may run on only a browser on the user's desktop or an app on their smartphone to gain access. For example, the system may utilize cloud computing to eliminate major upfront capital investments in local systems, the need to professionally manage data on site, and expensive software installation and deployment cycles, while delivering the most up-to-date software to all users automatically.

As shown in FIG. 3, the systems and methods may further include a data conversion module configured to receive the structured data and to convert the format of the structured data. In some embodiments, the data conversion module may be a configurable back-end module that takes the structured data (e.g. structured XML document) produced by the NLP engine and performs format conversions based upon the desired endpoints and system integrations.

The following formats may be available: (1) For EHRs/EMRs the data may be converted to an HL7 v2.x ADT or ORU message, or a CCD C32, C48, or C84 document. (2) For billing systems the data may typically be converted to an HL7 v2.x message that the majority of billing systems can accept. (3) For PHRs the data may be formatted into documents such as CCR and CCD. In some embodiments, if physicians choose, specific pieces of the note (e.g., diagnoses, procedures, vital signs, prescribed medications, etc.) can be sent directly to a widely available, consumer-oriented PHR such as Microsoft HealthVault or Google Health.

In some embodiments, the system may further include interfaces for structured input into multiple EHR products. Because the system converts raw patient data into standardized formats such as XML-based CCR and CCD, the system may have the potential to facilitate health information exchange (HIE) between EHR products and patient health portals like Google Health and Microsoft HealthVault that accept standard formats. This capability may help physicians meet the health record portability requirements of HIPAA as well as the ‘meaningful use’ requirements of recent federal ARRA/HITECH legislation.

As shown in FIG. 3, in some embodiments, the systems and methods may further include a routing module 315 configured to receive the formatted structured data and to send the formatted structured data to a secondary system 320. The routing module may inspect the configured endpoints (desired system integrations) and may send the appropriate converted data to their destination(s) through secure interfaces (e.g. via the internet). For example, in some embodiments, the secondary system is an Electronic Health or Medical Records (EHR/EMR) system and the data conversion module converts the data to at least one of a HL7 v2.x ADT, an ORU message, a CCD C32, a C48, or a C84 document. In some embodiments, the secondary system is billing system and the data conversion module converts the data to a HL7 v2.x message. In some embodiments, the secondary system is a Public Health Records (PHRs) system and the data conversion module converts the data to CCR and CCD. In some embodiments, the routing module may be further configured to maintain an audit log of all of the formatted structured data sent from the system.

In some embodiments, the routing module may create comprehensive data and metadata repositories (apart from EHRs) for use in comparative effectiveness evaluation and research trials, as well as studies on practice effectiveness, patient and physician behavior, and other workflow issues. Automating the structuring of captured data in the clinical note may provide a much larger amount of tagged data than conventional methods. The extensive structured data content from the system may support high-level analysis, such as clinical effectiveness evaluation, research trials, and clinical decision support.

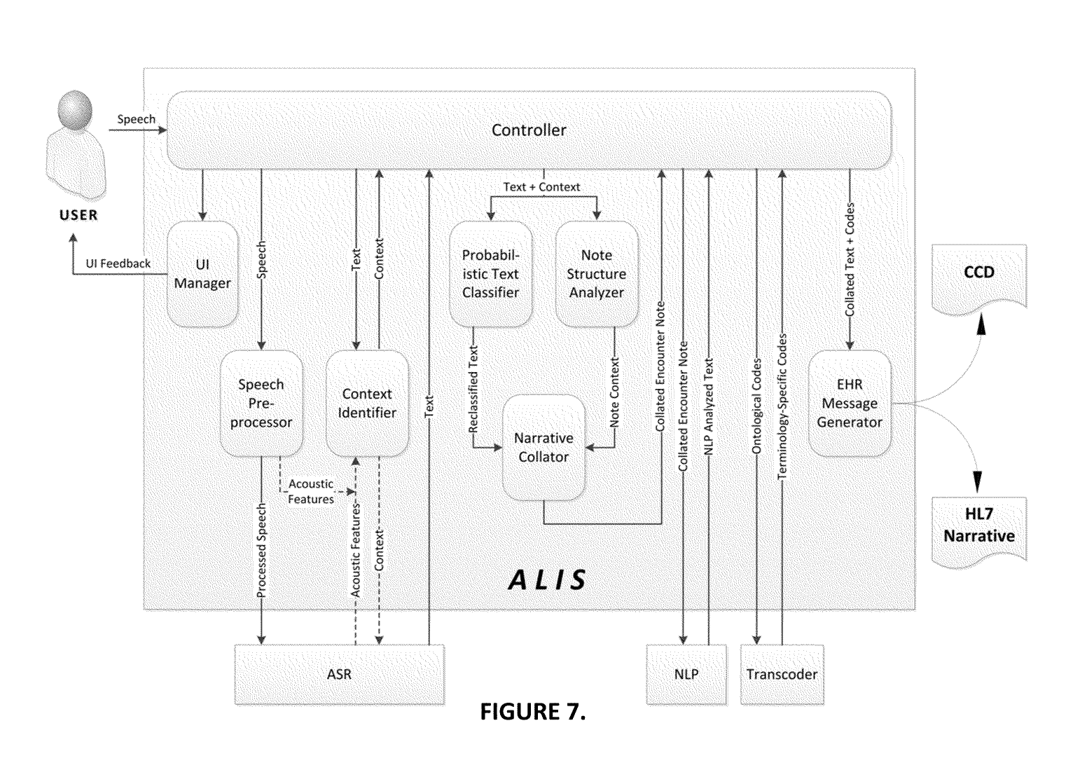

Referring to FIG. 7, as shown, the system described herein, specifically for example the NLP engine, may comprise an NLP based intuitive clinical language understanding module. In some embodiments, the module may be called an “Automated Language Intent System”, or ALIS. In some embodiments, the ALIS may include a controller, a speech processor, a context identifier, a probabilistic text classifier, a note structure analyzer, a narrative collector, an EHR message generator, a user interface manager, and/or any combination of elements thereof. ALIS may leverage components such as ASR, concept coding NLP, and HL7, to drive physician voice input to structured coded EHR data. ALIS may incorporate novel NLP algorithms and a deep understanding of clinical workflow to transform unstructured data into HL7 format. The cloud-based infrastructure may enable real-time processing and support for a highly responsive interactive asynchronous system.

In some embodiments, the controller manages the interactions within the system. The controller may control the flow of information between the components (internal and external) of the system and manage the workflow from input to output. The controller may enable flexibility in swapping components in and out from various sources such as vendor or open source.

In some embodiments, the speech preprocessor may be distributed between a user device and the server (computing cloud). In general, this component performs pre-recognition functions such as audio normalization, filtering, and distinguishing start and end of speech from background noise.

In some embodiments, the context identifier performs the natural language processing that identifies context within a window of real-time transcribed speech. It allows the user to move freely between chart sections, filling in data where appropriate and as directed by the patient encounter, without requiring specific commands. In some embodiments, the context identifier may be based on Hard State Charts and a library of dynamic behavior rules developed from deep analysis of physician workflow.

In some embodiments the probabilistic text classifier may use probabilistic measures to assign text to clinical note sections. It may examine the words captured within a context, compare them against patterns gleaned from a large corpus of notes, and suggest classification of phrases into appropriate areas within the encounter note.

In some embodiments, the note structure analyzer observes words captured within the various contexts and based upon metadata and learned information, and detects the type of note being dictated in real-time (such as H&P and SOAP formats).

In some embodiments, the narrative collator functions in tight coordination with the Note Structure Analyzer to collate the real-time transcribed text into a format suitable for the note type determined by the Note Structure Analyzer.

In some embodiments the EHR message generator may function to generate a CCD C32 v2.5 document which contains updates to the patient summary, and generate HL7 MDM messages that capture the encounter note text. These artifacts may then be then sent to the EHR system to update the patient summary and encounter notes.

In some embodiments, the UI manager may be a distributed computing layer that includes (1) Server-side components for collecting events to be delivered to the UI, formatting them to suit the characteristics of the end user's device or devices, and (2) Client-side components for rendering the events in the appropriate form on the UI. A physician can use the UI to make corrections at any time, which then initiates a rerun of the text through the entire system. The UI may include a feedback system, which is, in some embodiments, an Augmented Feedback Interface (AFI) that displays interactive feedback based on the real-time analysis of tagged data.

As shown, the ALIS may be coupled to an ASR engine, a concept coding NLP engine, and a transcoder. In some embodiments, speech may be captured either through a PC's integrated or attached microphone. The ASR engine may be cloud-based, incorporate partner core code, and may generate a complete, textual representation of the dictated note.

In some embodiments, the concept coding NLP engine or “partner” NLP engine may recognize semantic metadata (concepts, their modifiers, and the relationships between them) in the freeform textual object and maps them to relevant coded medical vocabulary such as SNOMED.

In some embodiments the transcoder takes the SNOMED-coded concepts and performs format conversions to return their closest matching codes from the requested specific terminology (such as ICD, RxNorm).

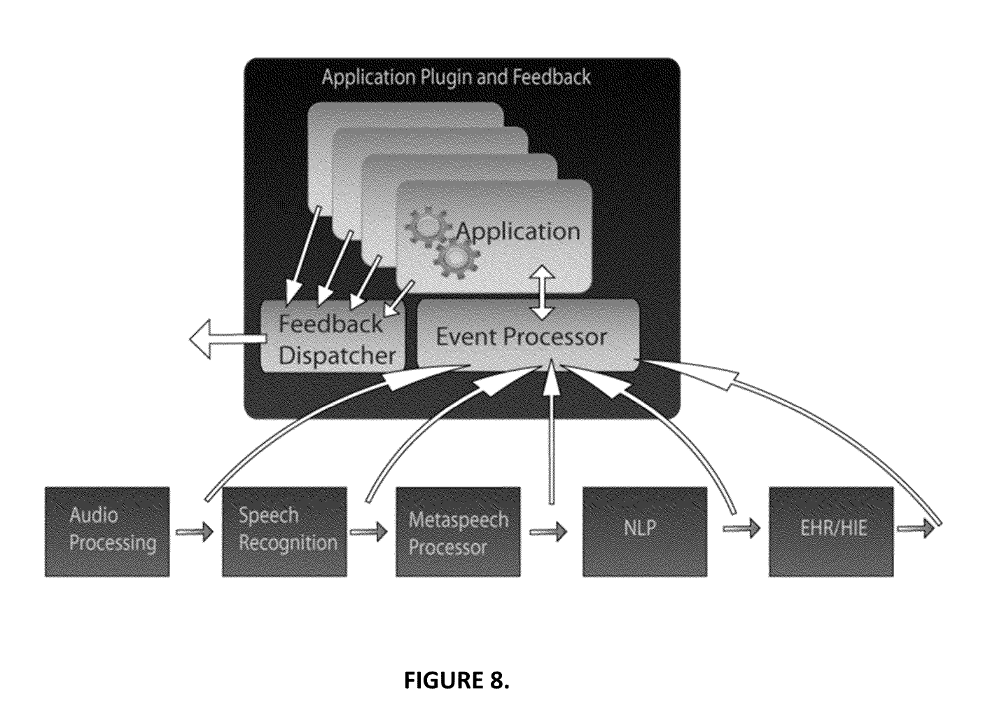

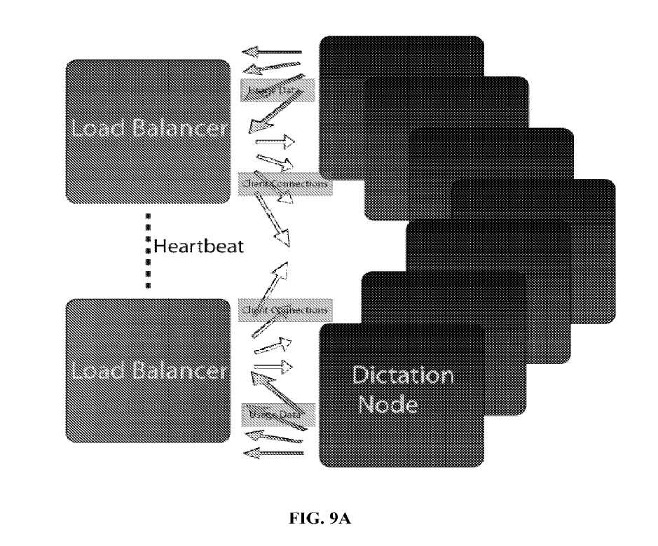

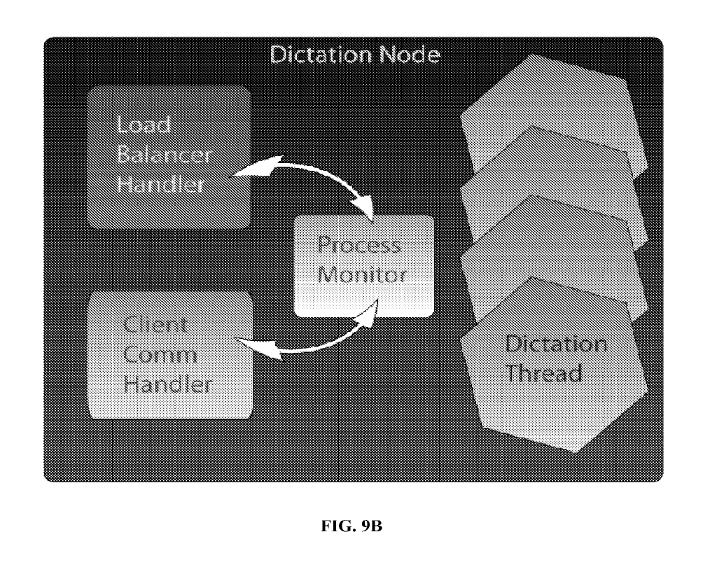

As shown in FIG. 8, the systems and methods described herein may further include a plug-in architecture that provide for the addition of specific functionality to the system. For example, the plug-in may allow for user-interactive applications. As shown in FIGS. 9A and 9B, the system may include architecture for a scalable ASR server. As shown, the architecture may include a plurality of dictation nodes. FIG. 9B details the architecture of a single dictation node.

In some embodiments, the systems and methods may further reduce usage and maintenance costs for physicians by operating as a Software as a Service (SaaS), where pricing is based on consumption and system maintenance costs are absorbed by the hosting service. Physicians may not need to purchase and install expensive hardware and software with long-term maintenance contracts. Software updates may be provided automatically with minimal disruption. Other advantages include robust third-party data center management of medical record data security, storage, and backup; availability of the system user interface through multiple channels such as desktop PCs, mobile computers, and smart phones; and ubiquitous access to the system and the EHR from any location at any time.

As described throughout, the systems and methods described herein may provide many benefits. Some of those benefits may include increasing workflow efficiency benefits physicians and patients; reducing cost benefits the physician and expands the healthcare IT market; portability of technology benefits physicians and industry; massive increase in data capture benefits patients, physicians, payers, researchers, and policy makers; broad analytics benefits patients, physicians, payers, researchers, and policy makers; and physicians controlling a valuable data source.

The systems and methods described herein may increase workflow efficiency and benefit physicians and patients. As physicians reduce patient contact time to address the demands of conventional structured charting, both provider and patient lose. The provider loses the enjoyment of patient contact and is overwhelmed by recording requirements. The patient feels rushed and ignored. By using the systems and methods described herein and allowing the provider to dictate rather than type their fully structured EHR data, charting time may be reduced by more than 80%. Allowing the physician to speak findings during the visit provides benefits to the patient, who then receives all the physician's attention and time set aside for the visit. The provider no longer returns to a pile of charts at each break.

The systems and methods described herein may reduce costs and benefit the physician and expand the healthcare IT market. By utilizing open source and low-cost core code and targeting small primary care practices, the system and methods' cloud-based solution maintains a price point that does not drain the decreasing revenues of small primary care practices, thus freeing more money into the system for patient care, physician income, and novel high value healthcare IT solutions.

The systems and methods described herein may provide portability of technology that benefit physicians and industry. The system and methods' physician-computer interface provides a layer of abstraction between the provider and the EHR. One of the common complaints by conventional EHR purchasers is the lock-in associated with implementation costs (including training) and stored data that is not easily transferable. An extra layer of abstraction aimed solely to improve the user interface device lowers the fear threshold and the end user learning curve associated with transition of an underlying EHR, thus lowering the entry barrier for innovative systems that would otherwise be locked out of installed customer bases. Physicians would be free to switch EHR systems, or alternatively, work in multiple settings with different EHRs and still retain the familiarity of a common interface.

The systems and methods described herein may provide massive increase in data capture benefits patients, physicians, payers, researchers, and policy makers. A significant part of the primary care clinical note in a typical EHR system is entered as free text. Generally, documentation is done with minimal inherent structure, which is either provided at a high level vis-à-vis content categories (e.g., problem list, allergies, etc.) or using specific, controlled dictionaries (e.g., medication lists). In the end, most of the clinical data contained within the conventional electronic clinical note ends up as minimally-structured free text. The NLP engine captures and organizes content within the note. There is a substantial difference between capturing only the structure entered conventionally by the physician (10-20% of potentially captured items) and capturing the entire semantic content of the note. Structured data represents information in a usable format, offering broad utility to all parties within the healthcare system.

The systems and methods described herein may provide broad analytics that benefits patients, physicians, payers, researchers, and policy makers. The significantly increased capture of structured data and semantics provides numerous opportunities for in-depth analysis. There is no comparison between the simple structured problem list in a traditional EHR and the extensive data on symptoms, severity, treatments, and results generated by a complete NLP solution. Based on robust de-identified aggregate data available from practices at their discretion, there may be opportunities for outcomes research, comparative effectiveness evaluation, research trials, and policy analysis.

The systems and methods described herein may allow physicians to control a valuable data source. Payers benefit from better quality outcomes and lower costs. Researchers and policy makers have the opportunity to work with physicians to obtain high quality de-identified data. Local analytics benefits patients, physicians, payers, researchers, and policy makers. The same increase in structured data also supports local practice analytics, enabling evidence-based quality improvement, compliance, workflow optimization, and personalization of patient experience. Local analytics shifts the performance curve for small and medium-sized (SMB) practices that are responsible for delivering the bulk of health care in the United States.

Various embodiments of systems and methods for transforming a speech input into machine-interpretable structured data are provided herein. Although much of the description and accompanying figures generally focuses on systems and methods that may be utilized with a speech input from a physician of an encounter note, in alternative embodiments, systems and methods of the present invention may be used in any of a number of data input systems and methods.

It must also be noted that as used herein and in the appended claims, the singular forms “a”, “an”, and “the” include plural reference unless the context clearly dictates otherwise. Thus, for example, reference to a “cell” is a reference to one or more cells and equivalents thereof known to those skilled in the art, and so forth. Unless defined otherwise, all technical and scientific terms used herein have the same meanings as commonly understood by one of ordinary skill in the art. Although any methods and materials similar or equivalent to those described herein can be used in the practice or testing of embodiments described herein, certain preferred methods, devices, and materials are described herein.

The examples and illustrations included herein show, by way of illustration and not of limitation, specific embodiments in which the subject matter may be practiced. Other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system for transforming a live speech input into machine-interpretable structured data, the system comprising:
an automated speech recognition (ASR) engine configured to receive a live speech input and to generate a text of the live speech input;
a natural language processing (NLP) engine configured to receive the text and to transform the text into machine-interpretable structured data; and
a user interface device configured to display the live speech input and a corresponding portion of the structured data in a predetermined order with respect to the structured data such that it may be reviewed, edited, or maintained as a record by a user.

2. The system of claim 1, wherein the display of the portion of the structured data provides real time feedback to the user.

3. A system for transforming a speech input into machine-interpretable structured data, the system comprising:
an automated speech recognition (ASR) engine configured to receive a speech input and to generate a text of the speech input;
a metaspeech processor configured to identify textual cues in the text and to modify the text based on the identified textual cues; and
a natural language processing (NLP) engine configured to receive the modified text and to transform the text into machine-interpretable structured data.

4. The system of claim 3, wherein the ASR engine is further configured to receive a portion of the machine-interpretable structured data in addition to the speech input and to generate a text with improved accuracy based on the combination of the speech input and the structured data.

5. The system of claim 3, wherein the speech input includes multiple subject matter sections that include at least two of a history of present illness section, a past medical history section, a past surgical history section, an allergies to medications section, a current medications section, a relevant family history section, and a social history section.

6. The system of claim 5, wherein the ASR engine is further configured to receive a portion of the structured data and to thereby classify a current subject matter section of the speech input based on the structured data and to change at least one of a lexicon and a word weighting used to generate the text according to the current subject matter section.

7. The system of claim 3, wherein identifying textual cues comprises at least one of identifying keywords in the text and identifying patterns in the text.

8. The system of claim 3, wherein the modification based on the identified textual cues includes at least one of organizing the text into sections and replacing words in the text.

9. The system of claim 3, wherein the modification based on the identified textual cues includes at least one of changing at least one of a lexicon and a word weighting used by the ASR engine to generate a text.

10. The system of claim 3, wherein the NLP engine is configured to employ an algorithm to scan the text and to apply syntactic and semantic rules to the text to transform the text into machine-interpretable structured data.

11. A method for transforming a speech input into machine-interpretable structured data, the method comprising:
generating a text from the speech input with an automated speech recognition (ASR) engine of a internet-based computer network;
identifying textual cues in the text;
modifying the text based on the textual cues by performing at least one of organizing the text into predetermined sections and substituting words in the text; and
transforming the modified text into machine-interpretable structured data with a natural language processing (NLP) engine of the internet-based computer network.

12. The method of claim 11, wherein the speech input comprises multiple subject matter sections include at least two of a history of present illness section, a past medical history section, a past surgical history section, an allergies to medications section, a current medications section, a relevant family history section, and a social history section.

13. The method of claim 12, wherein the generating a text step further comprises classifying the section of the speech input received by the ASR engine based on the structured data.

14. The method of claim 11, the identifying textual cues step further comprising at least one of identifying keywords and identifying patterns.

15. The method of claim 11, the modifying the text step further comprising at least one of organizing the text into sections and replacing words in the text.

16. The method of claim 11, the modifying the text step further comprising at least one of changing at least one of a lexicon and a word weighting used by the ASR engine in the generating a text step.

17. A method for transforming a speech input into machine-interpretable structured data, the method comprising:
receiving a speech input with an automated speech recognition (ASR) engine of an internet-based computer network;
generating a text from the speech input with the ASR engine using a first library;
transforming the text with a natural language processing (NLP) engine of the internet-based computer network into machine-interpretable structured data;
determining a context of the text based on the structured data;
generating an updated text from the speech input with the ASR engine using a second library selected based on the context of the text; and
transforming the updated text with the NLP engine of the internet-based computer network into updated machine-interpretable structured data.

18. The method of claim 17, wherein the first library is a general medical library.

19. The method of claim 17, wherein the second library is more specific than the first library.

20. The method of claim 19, wherein the second library is a context specific speech library.

21. The method of claim 17, wherein the determining a context of the text step further comprises performing a postprocessing analysis of the structured data.

22. The method of claim 17, wherein the speech input comprises multiple subject matter sections include at least two of a history of present illness section, a past medical history section, a past surgical history section, an allergies to medications section, a current medications section, a relevant family history section, and a social history section.

23. The method of claim 22, wherein the determining a context of the text step further comprises classifying the subject matter section of the speech input received by the ASR engine based on the structured data.

24. The method of claim 22, determining a context of the text step further comprising at least one of identifying keywords and identifying patterns.

25. The method of claim 22, determining a context of the text step further comprising scanning the text for keywords in the text.

26. The method of claim 22, determining a context of the text step further comprising employing an algorithm to scan the text and to apply syntactic and semantic rules to the text.

27. The method of claim 17, the transforming the text steps further comprising organizing the text into sections.

28. The method of claim 17, wherein the receiving a speech input step comprises receiving a speech input over the internet.

29. The method of claim 17, wherein the receiving a speech input step comprises receiving a speech input from a physician of an encounter note.

30. The method of claim 29, wherein the receiving a speech input step comprises receiving a speech input comprising at least one of a History and Physical (H&P) note or a Subjective, Objective, Assessment, and Plan (SOAP) note.

31. The method of claim 17, wherein the step of transforming the text comprises transforming the text into structured data in at least one of a Clinical Document Architecture (CDA), a Continuity of Care Record (CCR), and a Continuity of Care Document (CCD) format.

32. The method of claim 17, wherein the step of transforming the text comprises transforming the text into structured data that is configured to be compatible with at least one of health information exchanges (HIES), Electronic Medical Records (EHRs), and personal health records.
